(19) United States
(12) Patent Application Publication
(10) Pub. No.: US 2022/0291005 A1
(43) Pub. Date: Sep. 15, 2022

(54) SYSTEMS AND METHODS FOR OFF-ROUTE IDENTIFICATION

(71) Applicant: BEIJING DIDI INFINITY TECHNOLOGY AND DEVELOPMENT CO., LTD., Beijing (CN)

(72) Inventors: Cichang YE, Beijing (CN); Beijia SUN, Beijing (CN); Kaiqiang AN, Beijing (CN); Guoping LIU, Beijing (CN)

(73) Assignee: BEIJING DIDI INFINITY TECHNOLOGY AND DEVELOPMENT CO., LTD., Beijing (CN)

(21) Appl. No.: 17/804,085

(22) Filed: May 25, 2022

Related U.S. Application Data
(63) Continuation of application No. PCT/CN2020/131562, filed on Nov. 25, 2020.

(30) Foreign Application Priority Data
Nov. 25, 2019 (CN) 201911166999.6
Dec. 18, 2019 (CN) 201911311314.2

(51) Int. Cl. G01C 21/34; G01C 21/36

(52) U.S. Cl. CPC G01C 21/3492; G01C 21/3415; G01C 21/3438; G01C 21/3617

(57) ABSTRACT

Methods and systems for off-route identification may be provided. A first navigation route of an object that is traveling and one or more positioning location points during traveling may be obtained. Whether a first preset condition is satisfied may be determined based on a positional relationship between the one or more positioning location points and the first navigation route. In response to determining that the first preset condition is not satisfied, whether the object is off-route may be determined based on information associated with the traveling of the object.

### CROSS-REFERENCE TO RELATED APPLICATION

This application is a Continuation of International Patent Application No. PCT/CN2020/131562, filed on Nov. 25, 2020, which claims priority to Chinese Patent Application No. 201911166999.6 filed on Nov. 25, 2019, and Chinese Patent Application No. 201911311314.2 filed on Dec. 18, 2019, the entire contents of which are hereby incorporated by reference.

### TECHNICAL FIELD

The present disclosure relates to the technical field of navigation positioning, and in particular, to methods and systems for off-route identification.

### BACKGROUND

In daily travel, whether walking, driving, or taxiing, it is increasingly relying on navigation so that a destination may be quickly reached. However, in the process of walking or driving following the navigation, there are often cases of deviation from the navigation route due to objective reasons such as some road factors and objective reasons such as human factors. How to timely and accurately determine whether an object is off-route in during traveling is an urgent problem to be solved.

### SUMMARY

According to an aspect of the present disclosure, a method for off-route identification may be provided. The method may include: obtaining a first navigation route of an object that is traveling, and one or more positioning location point s during traveling; determining, based on a positional relationship between the one or more positioning location points and the first navigation route, whether a first preset condition is satisfied; and in response to determining that the first preset condition is not satisfied, determining whether the object is off-route based on information associated with the traveling of the object.

According to another aspect of the present disclosure, a system for off-route identification may be provided. The system may include: an obtaining module, configured to obtain a first navigation route of an object that is traveling, and one or more positioning location points during traveling; a judgement module, configured to determine, based on a positional relationship between the one or more positioning location points and the first navigation route, whether a first preset condition is satisfied; and a determination module configured to, determine whether the object is off-route based on information associated with the traveling of the object in response to determining that the first preset condition is not satisfied.

According to yet another aspect of the present disclosure, a device for off-route identification may be provided. The device may include at least one processor and at least one storage device for storing a set of instructions, wherein when the set of instructions are executed by the at least one processor, the device performs the method for off-route identification.

According to yet another aspect of the present disclosure, a computer-readable storage medium may be provided. The computer-readable storage medium may store computer instructions, wherein when a computer reads the computer instructions stored in the computer-readable storage medium, the computer performs the method for off-route identification.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an application scenario of an off-route identification system 100 according to some embodiments of the present disclosure;

FIG. 2 is a schematic diagram illustrating an exemplary computing device 200 according to some embodiments of the present disclosure;

FIG. 3 is a schematic diagram illustrating hardware and/or software components of an exemplary mobile device 300 according to some embodiments of the present disclosure;

FIG. 4 is a block diagram illustrating an exemplary processing device according to some embodiments of the present disclosure;

FIG. 5 is a flowchart illustrating an exemplary off-route identification process according to some embodiments of the present disclosure;

FIG. 6 is a flowchart illustrating an exemplary process for determining whether a first preset condition is satisfied according to some embodiments of the present disclosure;

FIG. 7 is a flowchart illustrating an exemplary process for determining whether an object is off-route according to some embodiments of the present disclosure;

FIG. 8 is a flowchart illustrating an exemplary off-route identification process according to some embodiments of the present disclosure;

FIG. 9 is a flowchart illustrating an exemplary off-route identification process according to some embodiments of the present disclosure;

FIG. 10 is a schematic diagram illustrating exemplary changes of the real-time navigation route after the object accepts the joint travel request according to some embodiments of the present disclosure;

FIG. 11 is a structural diagram illustrating an exemplary off-route identification system according to some embodiments of the present disclosure;

FIG. 12 is a structural diagram illustrating an exemplary off-route identification system according to some embodiments of the present disclosure;

FIG. 13 is a structural diagram illustrating an exemplary off-route identification system according to some embodiments of the present disclosure;

FIG. 14 is a schematic diagram illustrating an exemplary electronic device according to some embodiments of the present disclosure;

FIG. 15 is a flowchart illustrating an exemplary process for determining whether a first preset condition is satisfied according to some embodiments of the present disclosure;

FIG. 15 is a flowchart illustrating an exemplary process for determining whether a first preset condition is satisfied according to some embodiments of the present disclosure;

FIG. 16 is a flowchart illustrating an exemplary process for determining whether there is a mapping location point according to some embodiments of the present disclosure;

FIG. 17 is a flowchart illustrating an exemplary process for determining whether an object is off-route according to some embodiments of the present disclosure;

FIG. 18 is a flowchart illustrating an exemplary off-route identification process according to some embodiments of the present disclosure;

FIG. 19 is a flowchart illustrating an exemplary process for determining whether there is a mapping location point according to some embodiments of the present disclosure;

FIG. 20 is a flowchart illustrating an exemplary process for determining whether there is a mapping location point according to some embodiments of the present disclosure;

FIG. 21 illustrates an exemplary schematic diagram for selecting a mapping location point on the first navigation route according to some embodiments of the present disclosure;

FIG. 22 is a flowchart illustrating an exemplary process for determining whether an object is off-route according to some embodiments of the present disclosure;

FIG. 23 is a flowchart illustrating an exemplary process for determining whether a current positioning location point deviates from a navigation route according to some embodiments of the present disclosure;

FIG. 24 is a flowchart illustrating an exemplary off-route identification process according to some embodiments of the present disclosure;

FIG. 25 is a structural diagram illustrating an exemplary off-route identification system according to some embodiments of the present disclosure; and

FIG. 26 is a schematic diagram illustrating an exemplary electronic device according to some embodiments of the present disclosure.

### DETAILED DESCRIPTION

In order to illustrate technical solutions of the embodiments of the present disclosure, a brief introduction regarding the drawings used to describe the embodiments is provided below. Obviously, the drawings described below are merely some examples or embodiments of the present disclosure. Those having ordinary skills in the art, without further creative efforts, may apply the present disclosure to other similar scenarios according to these drawings. It should be understood that the exemplary embodiments are provided merely for better comprehension and application of the present disclosure by those skilled in the art, and not intended to limit the scope of the present disclosure. Unless obvious according to the context or illustrated specifically, the same numeral in the drawings refers to the same structure or operation.

It should be understood that the terms “system”, “device”, “unit” and/or “module” used in the specification are means used to distinguish different components, elements, parts, segments or assemblies. However, these words may be replaced by other expressions if they serve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added into the flowcharts. One or more operations may be removed from the flowcharts.

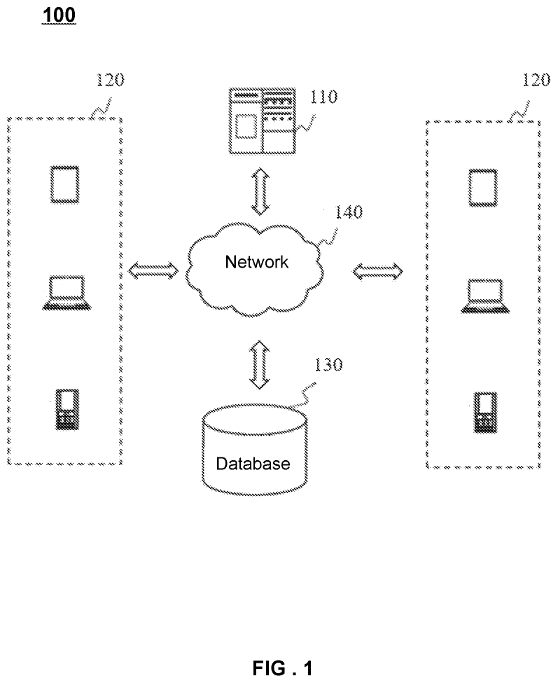

FIG. 1 is a schematic diagram illustrating an application scenario of an off-route identification system 100 according to some embodiments of the present disclosure.

The off-route identification system 100 may be applied to car hailing software, navigation software, or the like. In some embodiments, the off-route identification system 100 may determine whether an object is off-route.

In some embodiments, the off-route identification system 100 may be applied to an online hailing service platform that provides transportation services. The online hailing service platform may provide transportation services such as a taxi call, a driving service, a fast ride call, a carpool, a bus service, a driver employment, a pick-up service, and other transport services.

As shown in FIG. 1, the off-route identification system 100 may include a server 110, an object terminal 120, a database 130, and a network 140.

In some embodiments, the server 110 may be used to process information and/or data related to the off-route identification. In some embodiments, server 110 may be a single server or a server group. The server group may be centralized or distributed (e.g., server 110 may be a distributed system). In some embodiments, the server 110 may be local or remote. For example, server 110 may access information and/or data stored in the object terminal 120, and/or database 130 via the network 140. As another example, the server 110 may be directly connected to the object terminal 120, and/or the database 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may include a processing device. The processing device may process information and/or data related to service requests to perform one or more functions described in the present disclosure. For example, the processing device may determine whether the object terminal 120 is off-route based on a positioning location point of the object terminal 120 obtained from the object terminal 120 and a navigation route of the object terminal 120. In some embodiments, the processing device may include one or more sub-processing devices (e.g., single-core sub-processing device (s) or multi-core sub-processing device (s)). Merely by way of example, the processing device may include a central processing unit (CPU), an application-specific integrated circuit (ASIC), an application-specific instruction-set processor (ASIP), a graphics processing unit (GPU), a physical processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 140 may facilitate exchange of information and/or data. In some embodiments, one or more components of the off-route identification system 100 (e.g., the server 110, the object terminal 120, and the database 130) may send information and/or data to other components of the off-route identification system 100 via the network 140. For example, the server 110 may obtaining one or more positioning location points of the object terminal 120 during traveling from the object terminal 120 via the network 140. In some embodiments, the network 140 may be a wired network or a wireless network or the like, or any combination thereof. Merely by way of example, the network 140 may include a cable network, a wired network, a fiber optic network, a telecommunications network, an internal network, an Internet, a local area network (LAN), a wide area network (WAN), a wireless local area network (WLAN), a metropolitan area network (MAN), a public switched telephone network (PSTN), a bluetooth network, a zigbee network, a near field communication (NFC) network, or the like, or any combination thereof. In some embodiments, the off-route identification system 100 may include one or more network access points. For example, the network 140 may include wired or wireless network access points (e.g., base stations and/or Internet access points) through which one or more components of the off-route identification system 100 may be connected to the network 140 to exchange data and/or information.

In some embodiments, the object terminal 120 may include a tablet computer, a laptop, a mobile device, a motor vehicle built-in device, or the like, or any combination thereof. In some embodiments, the mobile device may include a smart home device, a wearable device, a smart mobile device, a virtual reality device, an augmented reality device, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. In some embodiments, the object terminal 120 may include a device with a positioning technique for determining positions of an object and/or the object terminal 120. In some embodiments, the object terminal 120 may include a service request terminal and/or a service provider terminal.

The database 130 may be used to store data and/or instructions. In some embodiments, the database 130 may store information obtained from the object terminal 120. In some embodiments, the database 130 may store data and/or instructions executed or used by the server 110 to perform the exemplary methods described in the present disclosure. In some embodiments, the database 130 may include a mass storage, a removable storage, a volatile read-and-write memory, a read-only memory (ROM), or the like, or any combination thereof. In some embodiments, the database 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 130 may be connected to the network 140 to communicate with one or more components of the off-route identification system 100 (e.g., the server 110, the object terminal 120, etc.). One or more components of the off-route identification system 100 may access the data or instructions stored in the database 130 via the network 140. In some embodiments, the database 130 may be directly connected to or communicate with one or more components of the off-route identification system 100 (e.g., the server 110, the object terminal 120). In some embodiments, the database 130 may be part of the server 110.

In some embodiments, one or more components (e.g., the server 110, the object terminal 120, etc.) in the off-route identification system 100 may access the database 130. In some embodiments, when one or more conditions are satisfied, one or more components (e.g., the server 110, the object terminal 120, etc.) in off-route identification system 100, may read and/or modify information related to the object and/or common general knowledge. For example, after that an object is in off-route is determined, the server 110 may modify/update navigation route information of one or more objects.

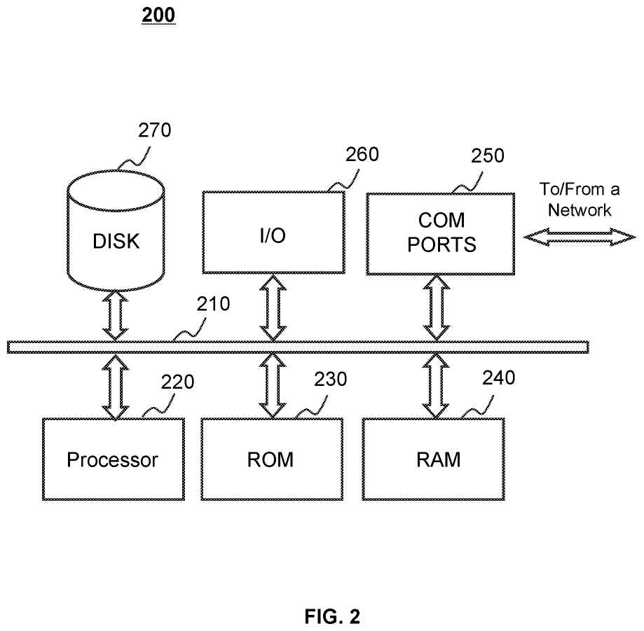

FIG. 2 is a schematic diagram illustrating an exemplary computing device 200 according to some embodiments of the present disclosure.

In some embodiments, the server 110 and/or the object terminal 120 (e.g., the service request terminal or the service provider terminal) may be implemented on the computing device 200. For example, the processing device 400 may implement and execute the functions disclosed in the present disclosure on computing device 200. As shown in FIG. 2, the computing device 200 may include an internal bus 210, a processor 220, a read-only memory (ROM) 230, a random memory (RAM) 240, a communication port 250, an input/output interface 260, and a hard disk 270.

The processor 220 may execute computing instructions (e.g., program codes) and perform functions of the off-route identification system 100 in accordance with techniques described in the present disclosure. The computing instructions may include programs, objects, components, data structures, procedures, modules, and functions (the functions refer to the particular functions described in the present disclosure). For example, the processor 220 may process images or text data obtained from any of the other components of the off-route identification system 100. In some embodiments, the processor 220 may include a microcontroller, a microprocessor, a reduced instruction set computer (RISC), an application specific integrated circuit (ASIC), an application specific instruction set processor (ASIP), a central processing unit (CPU), a graphics processing unit (GPU)), a physical processing unit (PPU), a microcontroller unit, a digital signal processor (DSP), a field programmable gate arrays (FPGA), an advanced RISC machine (ARM), a programmable logic device (PLD), and any circuits or processors capable of executing one or more functions, or the like, or any combination thereof. For illustrative purposes, the computing device 200 in FIG. 2 describes only one processor, but it should be noted that the computing device 200 in the present disclosure may also include a plurality of processors.

The storage devices of the computing device 200 (e.g., the ROM 230, the RAM 240, the hard disk 270, etc.) may store data/information obtained by any other components of the off-route identification system 100. Exemplary ROMs may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. Exemplary RAMs may include a dynamic RAM (DRAM), a double rate synchronous dynamic RAM (DDR SDRAM), a static RAM (SRAM), a thyristor RAM (T-RAM), and a zero capacitance (Z-RAM), etc.

The input/output interface 260 may be used to input or output signals, data or information. In some embodiments, the input/output interface 260 may enable an object to contact the off-route identification system 100. In some embodiments, the input/output interface 260 may include an input device and an output device. An exemplary input device may include a keyboard, a mouse, a touch screen, and a microphone, or the like, or any combination thereof. An exemplary output device may include a display device, a speaker, a printer, a projector, or the like, or any combination thereof. An exemplary display device may include a liquid crystal display (LCD), a light emitting diode (LED) based display, a flat panel display, a curved display, a television equipment, a cathode ray tube (CRT), or the like, or any combination thereof. The communication port 250 may be connected to a network for data communication. The connection may be a wired connection, a wireless connection, or a combination of both. The wired connection may include, for example, an electrical cable, an optical cable, a telephone wire, or the like, or any combination thereof. The wireless connection may include, for example, a Bluetooth link, a Wi-Fi link, a WiMax link, a WLAN link, a ZigBee link, a mobile network link (e.g., 3G, 4G, 5G, etc.), or the like, or any combination thereof. In some embodiments, communication port 250 may be and/or include a standardized port, such as RS232, RS485, etc. In some embodiments, the communication port 250 may be a specially designed communication port.

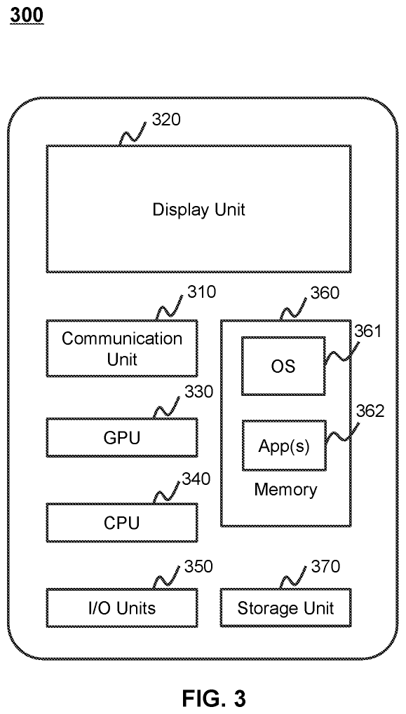

FIG. 3 is a schematic diagram illustrating hardware and/or software components of an exemplary mobile device 300 according to some embodiments of the present disclosure.

As illustrated in FIG. 3, the mobile device 300 may include a communication unit 310, a display unit 320, a graphics processing unit (GPU) 330, a central processing unit (CPU) 340, an I/O units 350, a memory 360, and a storage device 370. In some embodiments, an operating system 361 (e.g., iOS, Android, Windows Phone, etc.) and one or more applications 362 may be loaded into the memory 360 from the storage unit 370 in order to be executed by the CPU 340. The applications 362 may include a browser or any other suitable mobile apps for receiving texts, images, audioes, or other information from the off-route identification system 100. User interactions with the information stream may be achieved via the I/O 350 and provided to the processing device 120 and/or other components of the MRI system 100 via the network 150.

To implement various modules, units, and their functionalities described in the present disclosure, one or more computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to the off-route identification system 100 as described herein. A computer with user interface elements may be used to implement a personal computer (PC) or another type of workstation or terminal device, although a computer may also act as a server if appropriately programmed.

It should be noted that an initial navigation trajectory and the first navigation route may be a same concept, a secondary navigation trajectory and the second navigation route may be a same concept.

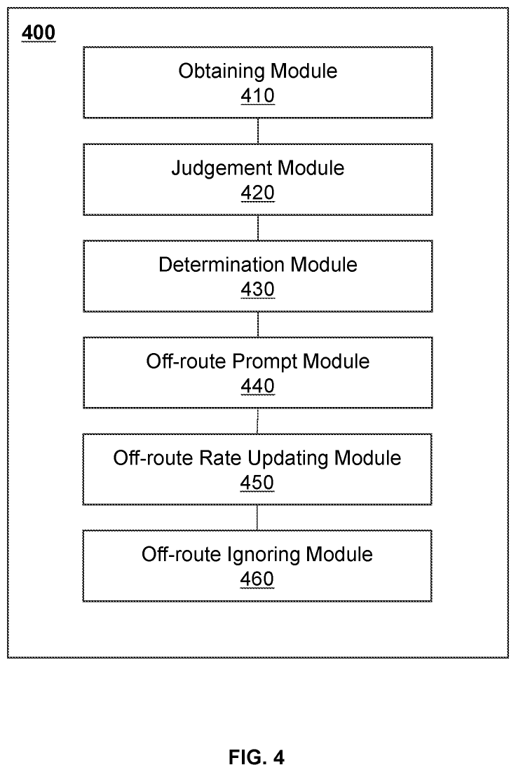

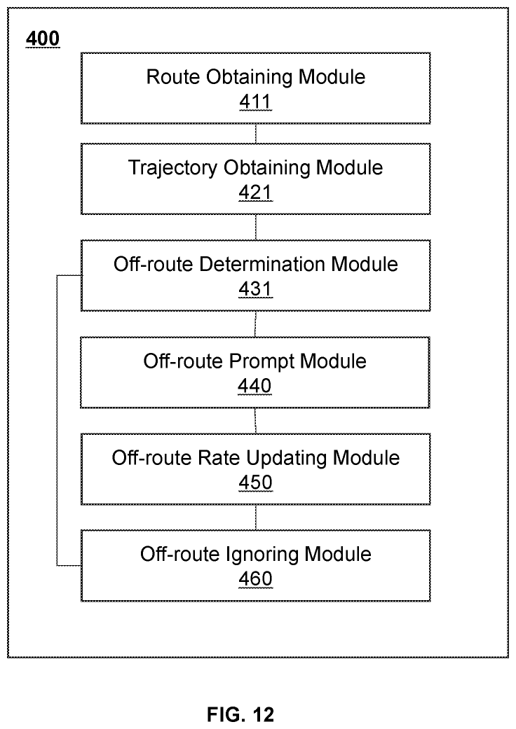

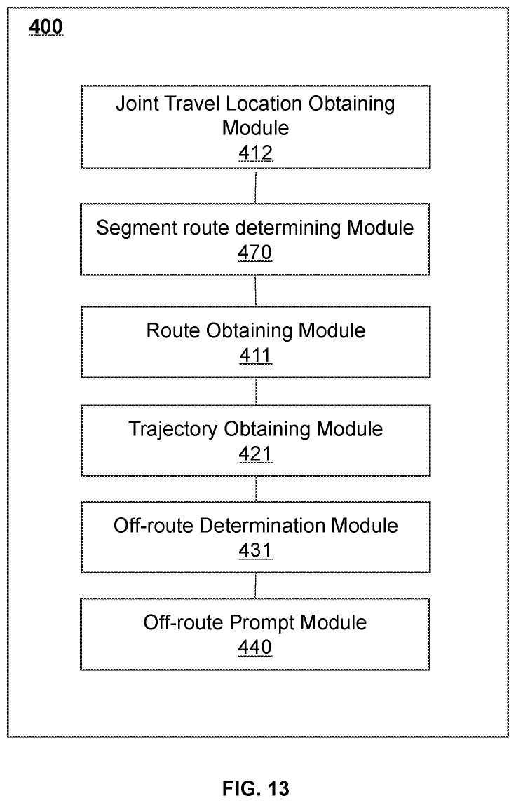

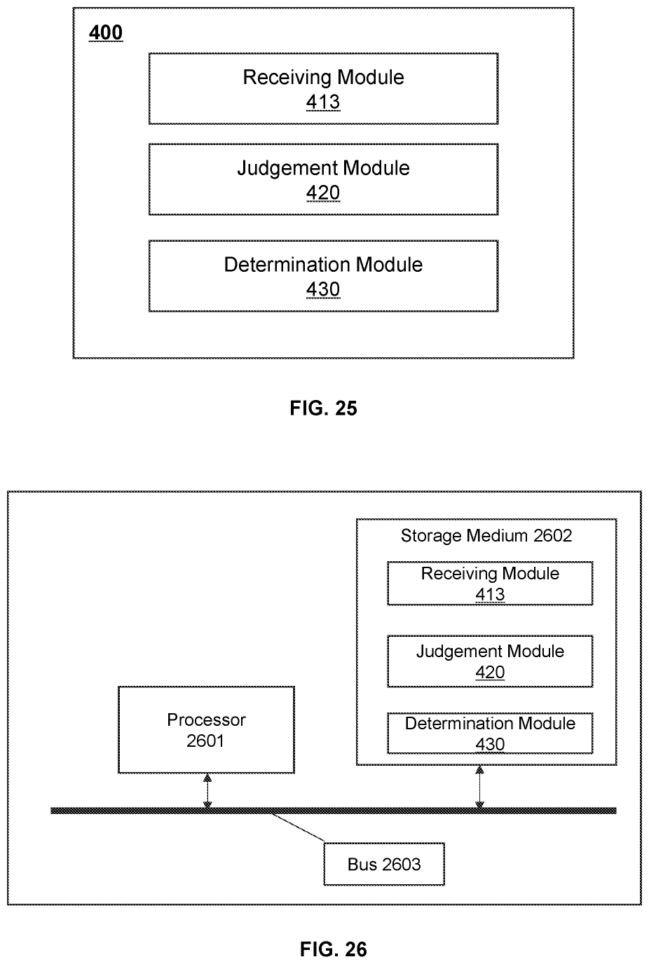

FIG. 4 is a block diagram illustrating an exemplary processing device according to some embodiments of the present disclosure. FIG. 11 is a structural diagram illustrating an exemplary off-route identification system according to some embodiments of the present disclosure. FIG. 12 is a structural diagram illustrating an exemplary off-route identification system according to some embodiments of the present disclosure. FIG. 13 is a structural diagram illustrating an exemplary off-route identification system according to some embodiments of the present disclosure. FIG. 25 is a structural diagram illustrating an exemplary off-route identification system according to some embodiments of the present disclosure.

As shown in FIGS. 4, 11-13, and 25, the processing device 400 of the off-route identification system may include an obtaining module 410, a judgement module 420, and a determination module 430.

The obtaining module 310 may be configured to obtain a first navigation route of an object that is traveling, and one or more positioning location points during traveling. The obtaining module 410 may include a plurality of sub-modules with different functions. For example, the obtaining module 410 may include a sub-module for obtaining the first navigation route and a sub-module for obtaining the one or more positioning location points.

In some embodiments, the obtaining module 410 may obtain information of the one or more positioning location points, such as position information and travelling direction information of the one or more positioning location points. the position information may include a coordinate. the travelling direction information may include a direction angle.

In some embodiments, for each of the one or more positioning location points, the obtaining module 410 may further be configured to obtain a precision factor, a direction angle and a speed value of the positioning location point; in response to determining that the precision factor of the positioning location point is not greater than a preset precision factor threshold, the direction angle of the positioning location point is not smaller than 0, and the speed value of the positioning location point is not smaller than 0, retaining information of the positioning location point; or in response to determining that the precision factor of the positioning location point is greater than the preset precision factor threshold, the directional angle of the positioning location point is smaller than 0, or the speed value of the positioning location point is smaller than 0, deleting the information of the positioning location point.

In some embodiments, the obtaining module 410 may include a route obtaining module 411. The route obtaining module 411 may be configured to obtain of the real-time navigation route of the object during traveling. The route obtaining module 411 may be configured to obtain the real-time navigation route determined by the object in each segment of the travel route based on the first departure point and the first travel destination. In some embodiments, the obtaining module 410 may include a joint travel location obtaining module 412. The joint travel location obtaining module 412 may be configured to obtain a second departure point and a second travel destination of the joint travel request, and a current positioning location point of the object in response to detecting that the object accepts a joint travel request during the traveling of the object.

A sub-module of the obtaining module 410 may be a receiving module 413. The receiving module 413 may be configured to receive the positioning location point information of the service provider terminal reported by the service provider terminal according to a set time interval when a current order is served. for received each piece of positioning location point information, the receiving module 413 may extract, a precision factor, a direction angle and a speed value of the positioning location point in the positioning location point information. in response to determining that the precision factor of the positioning location point is not greater than a preset precision factor threshold, the direction angle of the positioning location point is not smaller than 0, and the speed value of the positioning location point is not smaller than 0, the receiving module 413 may retain the information of the positioning location point. in response to determining that the precision factor of the positioning location point is greater than the preset precision factor threshold, the directional angle of the positioning location point is smaller than 0, or the speed value of the positioning location point is smaller than 0, the receiving module 413 may delete the information of the positioning location point.

In some embodiments, the obtaining module 410 (the joint travel location obtaining module 412) may be further configured to, during the traveling of the object, in response to detecting that the object accepts a joint travel request, and the first navigation route is a navigation route corresponding to a portion of a route from the first departure point of the object to the first travel destination of the object, determine the first navigation route based on a second departure point and a second travel destination in the joint travel request, a current positioning location point of the object, and the first travel destination.

The judgement module 420 may be configured to determine, based on a positional relationship between the one or more positioning location points and the first navigation route, whether a first preset condition is satisfied. the first preset condition may be configured to indicate that at least one of the one or more positioning location points does not deviate from the first navigation route.

In some embodiments, the judgement module 420 may be configured to determine whether there is an off-route point in the one or more positioning location points based on the positional relationship between the one or more positioning location points and the first navigation route; in response to determining that there is an off-route point in the one or more positioning location points, determine that the first preset condition is not satisfied.

In some embodiments, the obtaining module 410 and the judgment module 420 may be combined into a trajectory obtaining module 421. The trajectory obtaining module 421 may be configured to obtain historical travel routes corresponding to each historical travel order corresponding to the first departure point and the first travel destination of the object, the initial navigation trajectory before the real-time navigation route changes, and the secondary navigation trajectory generated after the real-time navigation route changes if it is detected that the real-time navigation route changes. The trajectory obtaining module 421 may further obtain a third navigation trajectory, a fourth navigation trajectory, etc. generated after the real-time navigation route changes again.

In some embodiments, the judgement module 420 may be configured to determine whether there is a mapping location point of a current positioning location point on the first navigation route based on a positional relationship between one or more positioning location points and a first navigation route; in response to determining that there is no mapping location point of the current positioning location point on the first navigation route, determine that the first preset condition is not satisfied. The determining of whether there is a mapping location point of a current positioning location point on the first navigation route based on a positional relationship between one or more positioning location points and a first navigation route may include: determining a first distance between each of the one or more positioning location points and the first navigation route based on position information of the one or more positioning location points; and determining whether there is the mapping location point of the current positioning location point on the first navigation route based on the one or more first distances. the determining of whether there is the mapping location point of the current positioning location point on the first navigation route based on the one or more first distances may include: determining one or more candidate mapping location points on the first navigation route based on the one or more first distances; and determining whether there is the mapping location point of the current positioning location point on the first navigation route based on travelling direction information of the one or more candidate mapping location points and travelling direction information of the current positioning location point. the determining of a first distance between each of the one or more positioning location points and the first navigation route based on position information of the one or more positioning location points may include: determining a vertical distance from each of the one or more positioning location points to the first navigation route based on the coordinates of the one or more positioning location points; and designating the one or more vertical distances as the one or more first distances. the determining of whether there is the mapping location point of the current positioning location point on the first navigation route based on the one or more first distances may include: determining an average vertical distance between the one or more positioning location points and the first navigation route based on the first distance between the each of the one or more positioning location points and the first navigation route; and determining whether there is the mapping location point of the current positioning location point on the first navigation route based on the average vertical distance, a coordinate of the current positioning location point, a direction angle of the current positioning location point, and a direction angle of the first navigation route. the determining of one or more candidate mapping location points on the first navigation route based on the one or more first distances may include: comparing a vertical distance of the current positioning location point to the first navigation route with the average vertical distance; in response to determining that the vertical distance of the current positioning location point to the first navigation route is greater than the average vertical distance, determining that there is no mapping location point of the current positioning location point on the first navigation route; or in response to determining that the vertical distance of the current positioning location point to the first navigation route is smaller than or equal to the average vertical distance, determining one or more points on the first navigation route whose distances from the current positioning location point are equal to the average vertical distance as the one or more candidate mapping location points based on the average vertical distance and the coordinate of the current positioning location point. the determining of whether there is the mapping location point of the current positioning location point on the first navigation route based on travelling direction information of the one or more candidate mapping location points and travelling direction information of the current positioning location point may include: determining whether there is at least one candidate mapping location point whose direction angle matches the direction angle of the current positioning location point from the one or more candidate mapping location points; in response to determining that there is at least one candidate mapping location point whose direction angle matches the direction angle of the current positioning location point, designating a candidate mapping location point corresponding to a direction angle that matches the direction angle of the current positioning location point as the mapping location point.

In some embodiments, the judgement module 420 may be configured to determine whether there is a mapping location point of a current positioning location point of a service provider terminal on a navigation route corresponding to a current order. In some embodiments, each piece of positioning location point information may include the coordinate and the direction angle of the positioning location point. the judgement module 420 may determine whether there is a mapping location point of the current positioning location point of the service provider terminal on the navigation route corresponding to the current order in the following manner. the judgement module 420 may determine the vertical distance from each positioning location point to the navigation route based on coordinates of a plurality of positioning location points including the current positioning location point corresponding to the current order. the judgement module 420 may determine an average vertical distance between the plurality of positioning location points and the navigation route according to the vertical distance from each positioning location point to the navigation route. the judgement module 420 may determine whether there is a mapping location point of the current positioning location point on the navigation route based on the average vertical distance, the coordinate of the current positioning location point, the direction angle of the current positioning location point and the direction angle of the navigation route. In some embodiments, the judgement module 420 may perform the following operations to determine whether there is a mapping location point of the current positioning location point on the navigation route based on the average vertical distance, the coordinate of the current positioning location point, the direction angle of the current positioning location point and the direction angle of the navigation route. the judgement module 420 may compare the vertical distance of the current positioning location point to the navigation route with the average vertical distance. in response to determining that the vertical distance of the current positioning location point to the navigation route is greater than the average vertical distance, the judgement module 420 may determine that there is no mapping location point of the current positioning location point on the navigation route. in response to determining that the vertical distance of the current positioning location point to the navigation route is smaller than or equal to the average vertical distance, the judgement module 420 may find one or more candidate location points on the navigation route whose distances from the current positioning location point are equal to the average vertical distance from the navigation route based on the coordinate of the current positioning location point and the average vertical distance. the judgement module 420 may determine whether there is at least one candidate location point at which the direction angle of the navigation route matches the direction angle of the current positioning location point. in response to determining that there is at least one candidate location point at which the direction angle of the navigation route matches the direction angle of the current positioning location point, the judgement module 420 may determine a candidate location point corresponding to a direction angle that matches the direction angle of the current positioning location point as the mapping location point.

The determination module 430 may be configured to determine whether the object is off-route based on information associated with the traveling of the object in response to determining that the first preset condition is not satisfied. For different information associated with the traveling of the object, the determination module 430 may include a plurality of sub-modules with different functions.

In some embodiments, the determination module 430 may be configured to determine whether the object is off-route based on at least one of the off-route rate, the first navigation route, or the second navigation route.

In some embodiments, the determination module 430 may be configured to determine the off-route rate. The determining of the off-route rate may include: obtaining one or more historical travel routes associated with the first navigation route; and determining, based on the one or more historical travel routes, the off-route rate at the at least one positioning location point that deviates from the first navigation route. the determining of the off-route rate at the at least one positioning location point that deviates from the first navigation routes based on the one or more historical travel routes may include: determining one or more first historical travel routes that are off-route from the at least one positioning location point that deviates from the first navigation route from the one or more historical travel routes; and determining the off-route rate based on a quantitative relationship between the one or more first historical travel routes and the one or more historical travel routes. the determining of whether the object is off-route based on at least one of the off-route rate, the first navigation route, or the second navigation route may include: determining whether the object is off-route based on the off-route rate and/or a relationship between the second navigation route and a third navigation route, wherein the third navigation route is a route from the at least one positioning location point that deviates from the first navigation route to the first travel destination in the first navigation route. the determining of whether the object is off-route based on the off-route rate and/or a relationship between the second navigation route and a third navigation route may include: in response to determining that the off-route rate is smaller than a preset off-route threshold, and/or a path length of the second navigation route is greater than a path length of the third navigation route, determining that the object is off-route.

In some embodiments, one of sub-modules of the determination module 430 may be an off-route determination module 431. The off-route determination module 431 may be configured to determine whether the object is off-routed based on the plurality of historical order trajectories, the initial navigation trajectory, and the secondary navigation trajectory. In some embodiments, the off-route determination module 431 may determine the off-route position of the object when the real-time navigation route changes. the off-route determination module 431 may determine the off-route rates at the off-route position based on the plurality of historical order trajectories. If the off-route rate is smaller than the preset off-route threshold, and the path length of the secondary navigation trajectory is greater than a path length of a route from the off-route position to the first travel destination in the initial navigation trajectory, it is determined that the object is off-route, wherein the secondary navigation trajectory may be a new route from the off-route position to the first travel destination generated after the real-time navigation route changes. In some embodiments, the off-route determination module 431 may perform the following operations to determine the off-route rates at the off-route position based on the plurality of historical order trajectories. According to the order information of each historical travel order corresponding to the departure point and the first travel destination, the off-route determination module 431 may determine historical order trajectories with off-route at the off-rout position from the plurality of historical order trajectories. the off-route determination module 431 may calculate a quantity ratio between historical order trajectories with off-route at the off-rout position and the plurality of historical order trajectories according to a count of historical order trajectories with off-route at the off-rout position and a count of the plurality of historical order trajectories, and determine the quantity ratio as the off-rout rate at the off-rout position.

In some embodiments, the determination module 430 may be configured to determine whether the object is off-route based on the information of the one or more positioning location points. the determining of whether the object is off-route based on the information of the one or more positioning location points may include: determining a second distance between each of the one or more positioning location points and the first navigation route; determining whether the current positioning location point deviates from the first navigation route based on the one or more second distances; and in response to determining that the current positioning location point deviates from the first navigation route, determining deviated positioning location points that deviate from the first navigation route from the one or more positioning location points; and determining whether the object is off-route based on information of the deviated positioning location points. the determining of whether the object is off-route based on information of the deviated positioning location points may include: determining, based on a count of the deviated positioning location points and a preset count threshold, whether the object is off-route. Before it is determined whether the current positioning location point deviates from the first navigation route based on the one or more second distances, the method may include: determining an average speed value of the object from the previous positioning location point to the current positioning location point based on the coordinate of the current positioning location point, a coordinate of a previous positioning location point of the current positioning location point, and an acquisition time interval between the current positioning location point and the previous positioning location point; in response to determining that the average speed value is smaller than or equal to a preset speed threshold, obtaining a variance of the precision factors of the plurality of positioning location points based on the precision factors of a plurality of positioning location points including the current positioning location point in the one or more positioning location points; and in response to determining that the average speed value is smaller than or equal to a preset speed threshold and the variance of the precision factors is smaller than a preset precision factor threshold, retaining the current positioning location point. the determining of a second distance between each of the one or more positioning location points and the first navigation route may include: determining a vertical distance from each of the one or more positioning location points to the first navigation route based on the coordinates of the one or more positioning location points; and designating the vertical distance as the second distance. the determining of whether the current positioning location point deviates from the first navigation route based on the one or more second distances may include: determining a distance variance of the one or more second distances based on the second distance between the each of the one or more positioning location points and the first navigation route; determining whether the distance variance exceeds a preset variance threshold; and in response to determining that the distance variance exceeds the preset variance threshold, determining that the current positioning location point deviates from the first navigation route.

In some embodiments, the determination module 430 may be configured to determine whether the service provider terminal deviates from the navigation route may be determined based on the vertical distances from multiple positioning location points including the current positioning location point corresponding to the current order to the navigation route in response to determining that there is no mapping location point on the navigation route. In some embodiments, after that there is a mapping location point on the navigation route is determined, the determination module 430 may be configured to replace the coordinate of the current positioning location point in the traveling trajectory information of the service provider terminal with the coordinate of the mapping location point, and send the updated traveling trajectory information of the service provider terminal to the service request terminal. the determination module 430 may perform the following operations to determine whether the service provider terminal deviates from the navigation route may be determined based on the vertical distances from multiple positioning location points including the current positioning location point corresponding to the current order to the navigation route in response to determining that there is no mapping location point on the navigation route. the determination module 430 may determine whether the current positioning location point deviates from the first navigation route based on the vertical distances from the multiple positioning location points to the first navigation route. in response to determining that the current positioning location point deviates from the navigation route, the determination module 430 may determine whether the service provider terminal deviates from the navigation route based on a count of positioning location points that deviate from the navigation route and a preset count threshold during the traveling of the service provider terminal. In some embodiments, each piece of location point information reported by the service provider terminal may include the precision factor and coordinate of the positioning location point. in response to determining that there is no mapping location point on the navigation route, before whether the current positioning location point deviates from the first navigation route is determined based on the vertical distances from the multiple positioning location points to the first navigation route, the determination module 430 may perform the following operations. the determination module 430 may determine an average speed value of the service provider terminal from the previous positioning location point to the current positioning location point may be determined based on the coordinate of the current positioning location point, a coordinate of a previous positioning location point of the current positioning location point, and an acquisition time interval between the current positioning location point and the previous positioning location point. in response to determining that the average speed value is smaller than or equal to the preset speed threshold, the determination module 430 may obtain a variance of the precision factors of the multiple positioning location points based on the precision factors of the multiple positioning location points. in response to determining that the variance of the precision factors is smaller than a precision factor threshold, the determination module 430 may retain the current positioning location point.

In some embodiments, the processing device 400 of the off-route identification system may further include an off-route prompt module 440, an off-route rate updating module 450, an off-route ignoring module 460, and a segment route determining module 470.

The off-route rate updating module 450 may be configured to determine the off-route rate at the off-route position of the object for this traveling based on plurality of historical order trajectories and the actual route of the object that is traveling along the real-time navigation route in response to determining that the object is off-route, and use the determined off-route rate to update the off-route rate in the basic road network data for travels of the object prior to this traveling of the object. The actual route may include a route between the object traveling from the first departure point to the off-route position in the initial navigation trajectory and the secondary navigation trajectory.

In some embodiments, in response to determining that the object is off-route, off-route rate updating module 450 may be configured to determine a new off-route rate at the at least one location point that deviates from the first navigation route based on one or more historical travel routes and the actual travel route of the object, and update the off-route rate at the at least one positioning location point using the new off-route rate.

The off-route rate updating module 450 may be configured to send an off-route prompt to the object in response to determining that the object is off-route. In some embodiments, the off-route rate updating module 450 may perform the following operations to send an off-route prompt to the object in response to determining that the object is off-route. in response to determining that the object is off-route, the off-route rate updating module 450 may determine a historical order trajectory without off-route at the off-route position among the plurality of historical order trajectories. the off-route rate updating module 450 may determine a route similarity between the secondary navigation trajectory and the historical order trajectory without off-route. the off-route rate updating module 450 may send the route similarity between the secondary navigation trajectory and the historical order trajectory without off-route and the off-route prompt to the object.

In some embodiments, the off-route rate updating module 450 may perform one or more of the following operations. In response to determining that the object is off-route, the off-route rate updating module 450 may determine a second historical travel route that is not off-route at the at least one positioning location point that deviates from the first navigation route from the one or more historical travel routes. The off-route rate updating module 450 may determine a route similarity between the second navigation route and the second historical travel route. the off-route rate updating module 450 may send the route similarity to the object.

The off-route ignoring module 460 may be configured to ignore the change of the real-time navigation route in response to determining that the object is not off-route.

In some embodiments, the segment route determining module 470 may be configured to determine a first departure point and a first travel destination of the object corresponding to each segment of the travel route based on the second departure point and the second travel destination, the current positioning location point of the object, and the first travel destination. In some embodiments, the segment route determining module 470 may perform the following operations to determine a first departure point and a first travel destination of the object corresponding to each segment of the travel route based on the second departure point and the second travel destination, the current positioning location point of the object, and the first travel destination. the segment route determining module 470 may determine a travel order of the object from the real-time location to the second departure place, the second travel destination and the first travel destination in turn based on the geographic location of the second departure point, the geographic location of the second travel destination, the geographic location of the real-time location, and the geographic location of the first travel destination. the segment route determining module 470 may determine each adjacent two locations as the departure point and destination of each segment route, the navigation route between each adjacent two locations, and the real-time navigation route corresponding to the navigation route according to the travel order.

In some embodiments, the processing device 400 of the off-route identification system may further include an information replacing module. the information replacing module may be configured to replace position information of the current positioning location point with position information of the mapping location point in response to determining that there is the mapping location point of the current positioning location point on the first navigation route.

In some embodiments, the processing device 400 of the off-route identification system may further include a count updating module. the count updating module may be configured to update the count of the deviated positioning location points in response to determining that the current positioning location point deviates the first navigation route. the determining of whether the object is off-route based on a count of the deviated positioning location points and a preset count threshold may include determining that the object is off-route in response to determining that the updated count of the deviated positioning location points is greater than or equal to the preset count threshold.

the processing device 400 of the off-route identification system may further include a route updating module. the route updating module may be configured to update the first navigation route based on the information of the deviated positioning location points and the information of the current positioning location point in response to determining that the object is off-route.

It should be understood that the system and modules shown in FIG. 4 may be implemented in various ways. For example, in some embodiments, the system and its modules may be implemented by hardware, software, or a combination of both. The hardware may be implemented using dedicated logic. The software may be stored in a memory, executed by an appropriate instruction execution system, such as a microprocessor or a dedicated design hardware. Those skilled in the art will appreciate that the methods and systems described above may be implemented using computer-executable instructions and/or processor control code, for example, such code are provided on a carrier medium such as a disk, CD or DVD-ROM, or a programmable memory of a read-only memory (firmware), or a data carrier such as an optical or electronic signal carrier. The system and its modules of the present disclosure may not only be implemented by very large scale integrated circuits (VLSIs), gate arrays, semiconductors such as logic chips, transistors, etc., or hardware circuits of programmable hardware devices such as field programmable gate arrays, programmable logic devices, etc., but also be implemented by, for example, the software executed by varieties of processors, or implemented by a combination of the hardware circuits and the software (e.g., firmware) described above.

It should be noted that the above descriptions for the processing device 400 and its modules of the off-route identification system are for description convenience only, and the present disclosure should not be limited to the scope of the embodiments mentioned. It will be appreciated that for those skilled in the art, after understanding the principle of the system, the individual modules may be arbitrarily combined without departing from this principle, or the subsystem is connected to other modules. For example, the obtaining module 410, the judgement module 420, and the determination module 430 may be different modules in a system, or a module implementing the functions of two or more modules described above. As another example, each module may share a storage module, or each module may also have an individual storage module. The variations like these are within the scope of the present disclosure.

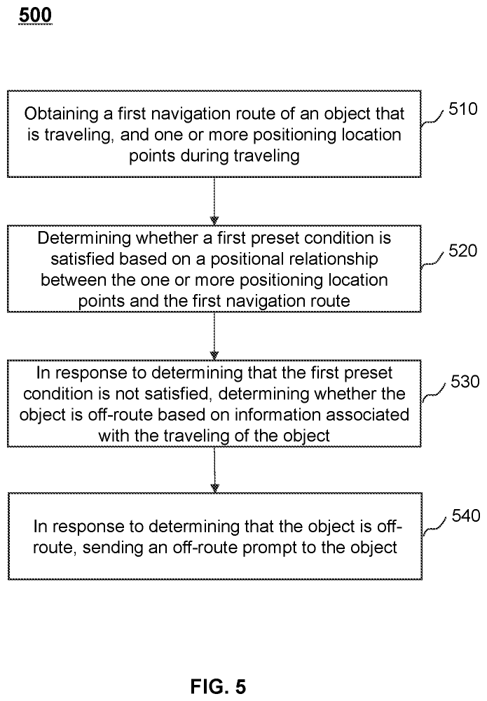

FIG. 5 is a flowchart illustrating an exemplary off-route identification process according to some embodiments of the present disclosure. As shown in FIG. 5, the process 500 may include one or more of the following operations. In some embodiments, the process 500 may be executed by the processing device 400.

In 510, the processing device 400 may obtain a first navigation route of an object that is traveling, and one or more positioning location points during traveling.

Specifically, operation 510 may be executed by the obtaining module 410. The objects may be a device, a terminal, a vehicle, or an object, etc. to be off-route identification. For example, the object may be a service requester using a car hailing software, a service provider using a car hailing software, a service request terminal held by the service requester, a service provider terminal held by the service provider, or a vehicle of the service provider, etc., or the object may be an object using a navigation software, a terminal held by the object, a vehicle driven by object, etc.

In some embodiments, the object may be a drone that performs an aerial task or a delivery task. In other embodiments, the object may be a transported entity, such as a product, a takeaway, a cargo, a driver, a passenger, a pet, etc.

The first navigation route may be a navigation route planned for the object based on information such as a first departure point of the object, a first travel destination of the object, and/or road conditions at the beginning of the travel. The first navigation route may be planned based on preset conditions (e.g., avoiding congestion, shortest time, shortest route, least traffic lights, least toll), preset algorithms, etc. In some embodiments, the first departure point of the first navigation route may be a current position of a service vehicle using a car hailing software, and the first travel destination may be a pickup point of a taxi user. In some embodiments, the first departure point of the first navigation route may be a pick-up point of the taxi user, and the first travel destination may be a drop-off point (i.e., the travel destination) of the taxi user. In some embodiments, the first navigation route may be generated according to the departure point of the object, the first travel destination, and one or more common joint travel requests. The first navigation route may be composed of multiple intermittent or continuous routes. In other embodiments, the object may change destinations during traveling, and the first navigation route may include a route between the first departure point and the real-time location of the object when the first travel destination is changed and a route between the real-time location of the object when the first travel destination is changed and the changed first travel destination.

In some embodiments, during the traveling of the object, in response to detecting that the object accepts a joint travel request, and the first navigation route is a navigation route corresponding to a portion of a route from the first departure point of the object to the first travel destination of the object, the first navigation route may be determined based on a second departure point and a second travel destination in the joint travel request, a current positioning location point of the object, and the first travel destination. For example, the first navigation route may be a navigation route between the second departure point of the joint travel request and the current positioning location point, a navigation route between the second departure point and the second travel destination, or the like. The service provider terminal held by the service provider may receive the joint travel request.

In some embodiments, the object may be the service provider terminal. The first navigation route of the object that is traveling may be a navigation route corresponding to a current order of the service. The one or more positioning location points may be positioning location points of the service provider terminal reported by the service provider terminal for a present time interval when the current order is serviced.

In some embodiments, the first navigation route may be an initial navigation trajectory when the traveling of the object is started. The initial navigation trajectory may refer to a navigation route corresponding to an initial navigation route generated according to a first departure point and a first travel destination of an initial object before the real-time navigation route changes, or it may refer to navigation routes between the real-time locations of the remaining objects on the initial navigation route and the first travel destination during traveling according to the initial navigation route before the real-time navigation route changes.

In some embodiments, the first navigation route may be obtained by the obtaining module 410 after the first navigation route is generated by a terminal held by the object. In other embodiments, the first navigation route may also be generated by the obtaining module 410. It should also be noted that the navigation route may be a suggested travel route planned by the server or the object terminal device for the object, and the travel route may be a route of the object that is traveling.

In some embodiments, the one or more positioning location points may be obtained at intervals during the traveling of the object. Among the one or more positioning location points, any two adjacent positioning location points may be obtained based on the same interval time, or are obtained based on different intervals. In some embodiments, the one or more positioning location points may include at least a current positioning location point. The current positioning location point may be a positioning location point whose acquisition time is closest to the current time among the positioning location points obtained during traveling.

In some embodiments, the positioning location points may be trajectory points or a combination of trajectory points in a route of the object that has traveled. For example, during the traveling of the object, a time when the first navigation route is generated may be determined as an initial time, a real-time location of the object may be obtained every 1 minute and designated as a trajectory point, and a trajectory point may be determined as a positioning location point. As another example, during the traveling of the object, the time when the first navigation route is generated may be determined as the initial time, and the real-time location of the object may be obtained every 10s and determined as a trajectory point, and six consecutive trajectory points A, B, C, D, E, F may be obtained, and three consecutive trajectory points may form a positioning location point (e.g., taking a average position of the three trajectory points), that is, trajectory points A, B, and C may form one positioning location point, and trajectory points D, E, and F may form another positioning location point.

In operation 510, the obtaining of the positioning location points may further include obtaining information of the positioning location points. The information of the positioning location points may include position information of the positioning location points, travelling direction information at the positioning time, travelling speed information at the positioning time, signal strength information, signal source information, positioning method information, or the like.

The obtaining of the positioning location points may include at least obtaining the position information of the positioning location points. The position information of the positioning location points may be obtained using a global positioning system (GPS), a global navigation satellite system (GLONASS), a Galileo positioning system, or the like, or any combination thereof. In some embodiments, the position information of the positioning location points may also be obtained based on a Beidou navigation system or other satellite-based positioning method. The position information of the positioning location points may also be obtained based on a base station positioning method, a WiFi access point positioning method, or the like. For example, when the position information of the positioning location points is obtained by the base station positioning method, position information of a device to be located may be obtained based on a time difference and/or a signal strength of the communication between the base station and the device to be located. As another example, when the position information of the positioning location point is obtained by the WiFi access point positioning method, the position information of the device to be located may be determined by determining a location of the WiFi access point and a distance between the device to be located and the WiFi access point, etc.

In some embodiments, the obtaining of the positioning location points may further include: for each of the one or more positioning location points, obtaining a precision factor, a direction angle and a speed value of the positioning location point; in response to determining that the precision factor of the positioning location point is not greater than a preset precision factor threshold, the direction angle of the positioning location point is not smaller than 0, and the speed value of the positioning location point is not smaller than 0, retaining information of the positioning location point; or in response to determining that the precision factor of the positioning location point is greater than the preset precision factor threshold, the directional angle of the positioning location point is smaller than 0, or the speed value of the positioning location point is smaller than 0, deleting the information of the positioning location point. The precision factor is a very important coefficient to measure the positioning accuracy. The precision factor may indicate a distance vector amplification factor between a receiver and a space satellite caused by the GPS ranging error. The direction angle of a positioning location point may be an angle formed between the direction of the traveling and a preset direction (e.g., the due north, the due south, etc.).

In some embodiments, a positioning location point may be represented by coordinates, e.g., latitude and longitude coordinates. In other embodiments, a positioning location point may be represented by a cluster center or a geometric center of at least one reference location point. A reference location point may be a location point obtained by any of the above positioning techniques. For example, a reference location point A of the object may be obtained by the satellite positioning, a reference location point B may be obtained by the WiFi access point positioning, and a reference location point C may be obtained by the base station positioning. The cluster center or the geometric center of reference location point A, reference location point B, and reference location point C may be the positioning location point of the object.

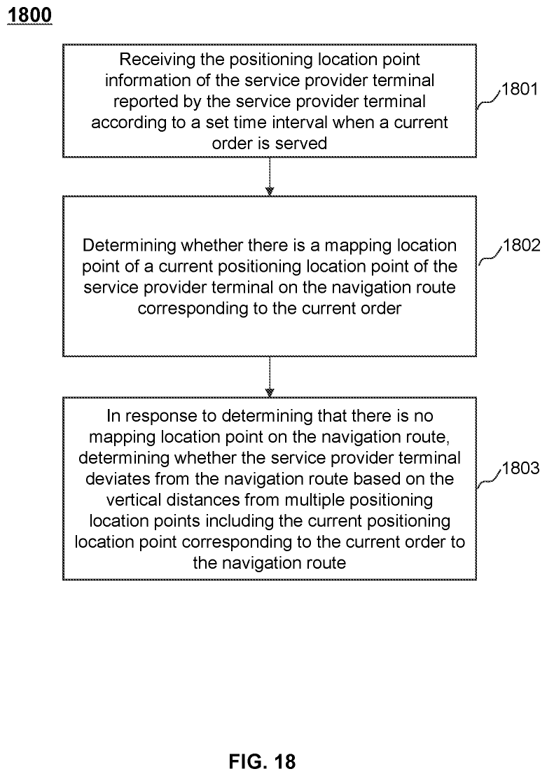

In some embodiments, after the one or more positioning location points are obtained, each positioning location point may be preprocessed. For example, information of received each positioning location point may be detected. More descriptions for preprocessing of the positioning location points may be found in operation 1801 in FIG. 18 and the descriptions thereof, and the descriptions of which are not repeated here.

In 520, the processing device 400 may determine whether a first preset condition is satisfied based on a positional relationship between the one or more positioning location points and the first navigation route. Specifically, operation 520 may be performed by the judgement module 420.

The positional relationship between the one or more positioning location points and the first navigation route may be a spatial relative relationship between the positioning location points and the first navigation route. The positional relationship may include distances between the positioning location points and the first navigation route (if not specified, the distances described here and below may be understood as horizontal distances), height differences between the positioning location points and the first navigation route (which may be vertical distances), or the like. In some embodiments, the positional relationship between the positioning location points and the first navigation route may be represented by coordinates. Merely by way of example, a vertical distance between each positioning location point and the first navigation route may be determined based on the coordinates, and then positional relationship between the positioning location points and the first navigation route may be determined based on the vertical distance between each positioning location point and the first navigation route. In some embodiments, if the vertical distance between a positioning location point and the first navigation route is smaller than or equal to a preset distance threshold, it can indicate that the positioning location point is located on the first navigation route; if the vertical distance between a positioning location point and the first navigation route is greater than the preset distance threshold, it can indicate that the positioning location point is not located on the first navigation route. The preset distance threshold may be set or adjusted according to actual application (e.g., the strength of the positioning signal).

The first preset condition may be configured to indicate that at least one of the one or more positioning location points does not deviate from the first navigation route. It should be noted that the one or more positioning location points deviate from the first navigation route do not mean that the object is off-route. That the one or more positioning location points deviate from the first navigation route may be caused by inaccurate positioning, or because the object is traveling on a better route than the first navigation route. Therefore, after whether the first preset condition is satisfied is determined, a further determination operation needs to be performed to determine whether the object is off-route. That is, if the first preset condition is not satisfied, it means that at least one positioning location point deviates from the first navigation route. In some embodiments, that the first preset condition is not satisfied may indicate that at least one positioning location point deviates from the first navigation route. The at least one positioning location point that deviates from the first navigation route may include the current positioning location point, a previous positioning location point of the current positioning location point or a next positioning location point of the current positioning location point.

In some embodiments, the first preset condition may be that there is an off-route point in the one or more positioning location points. The off-route point may be understood as a location point that deviates from the first navigation route, which may be a location point whose distance from the first navigation route is greater than a preset distance threshold. The deviation of the off-route point from the first navigation route may be due to the positioning deviation (e.g., the positioning deviation caused by a weak positioning signal), it may also be because the object does not follow the first navigation route, it may be because the object is traveling on a better travel route, which is not necessarily the case that the object is off-route. Whether there is an off-route point in the one or more positioning location points may be determined based on the positional relationship between the one or more positioning lo cation points and the first navigation route. In response to determining that there is an off-route point in the one or more positioning location points, that the first preset condition is not satisfied may be determined. In response to determining that there is no off-route point in one or more positioning location points, that the first preset condition is satisfied may be determined.

In some embodiments, that there is an off-route point in the one or more positioning location points (i.e., the first preset condition is not satisfied) may be understood as that the real-time navigation route changes. The real-time navigation route may be an initial navigation route generated according to the first departure point and the first travel destination obtained by the object when the object starts to travel. The real-time navigation route may be a navigation route between the real-time location of the object on the initial navigation route and the first travel destination when the object travels along the initial navigation route. When the object travels according to the initial navigation route, the travel plan may be changed, for example, the first travel destination may be changed, or the object need to go to other places first, etc., and the real-time navigation route may also be a navigation route obtained according to the real-time location of the object on the initial navigation route and the changed first travel destination. Preferably, in some embodiments of the present disclosure, the real-time navigation route may refer to a navigation route between the real-time location of the object on the initial navigation route and the first travel destination.

Wherein, the change of the real-time navigation route may refer to that the starting point and/or the ending point corresponding to the real-time navigation route (e.g., the real-time location of the object and the first travel destination) remain unchanged, but the navigation route between the starting point and the ending point changes.

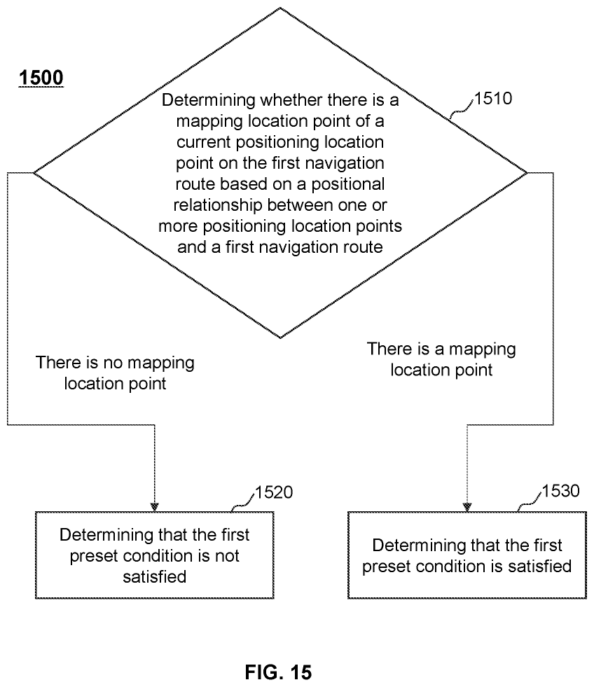

In some embodiments, the first preset condition may be that there is a mapping location point of the current positioning location point on the first navigation route. More descriptions for the determination of there is a mapping location point of the current positioning location point on the first navigation route may be found in FIG. 15 and the descriptions thereof, and the descriptions of which are not repeated here. Whether there is a mapping location point of the current positioning location point on the first navigation route may be determined based on the positional relationship between the one or more positioning location points and the first navigation route. In response to determining that there is no mapping location point of the current positioning location point on the first navigation route, that the first preset condition is not satisfied may be determined. In response to determining that there is a mapping location point of the current positioning location point on the first navigation route, that the first preset condition is satisfied may be determined.

In some embodiments, coordinate information of a positioning location point may be obtained, and a circle may be determined according to a radius with the positioning location point as the center of the circle. Whether there is a trajectory point of the first navigation route in the circle may be determined. In response to determining that there is a trajectory point of the first navigation route in the circle, that the positioning location point does not deviate from the first navigation route and the first preset condition is satisfied may be determined. In response to determining that there is no trajectory point of the first navigation route in the circle, that the positioning location point deviates from the first navigation route and the first preset condition is not satisfied may be determined.

In 530, in response to determining that the first preset condition is not satisfied, the processing device 400 may determine whether the object is off-route based on information associated with the traveling of the object. Specifically, operation 530 may be performed by the determination module 430.

The information associated with the traveling of the object may be information associated with the current travel of the object. For example, the information associated with the traveling of the object may include navigation route information, travel route information, positioning location point information, first departure point information, first travel destination information, travel route point information, road network environment information, or the like.

In some embodiments, the off-route may be a state in which the object is not traveling according to the predetermined navigation route (i.e., traveling on a route other than the predetermined navigation route). The off-route may also be understood as that deviates from a normal and reasonable travel route (e.g., taking a wrong road). In some embodiments, when the first preset condition is that there is an off-route point in the one or more positioning location points, the information associated with the traveling of the object may include an off-route rate, the first navigation route, or the like. In other embodiments, when the first preset condition is that there is a mapping location point of the current positioning location point on the first navigation route, the information associated with the traveling of the object may include the information (e.g., position information, travelling direction information, etc.) of the positioning location points.

In 540, in response to determining that the object is off-route, the processing device 400 may send an off-route prompt to the object. Specifically, operation 540 may be performed by the off-route prompt module 440.

In some embodiments, when that the object is off-route is determined, the processing device 400 may send an off-route prompt to the object. For example, the processing device 400 may send the off-route prompt to a terminal used by the object, a vehicle-mounted navigation terminal, etc. The terminal may notify the object of the off-route prompt through voice prompts (e.g., a voice broadcast of “You have been off-route”), text prompts on a display screen (e.g., a text prompt of “You have been off-route”), image prompts on a display screen, etc.

It should be noted that the above description regarding the methods and systems for off-route identification is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. Multiple operations may be split, merged, or the order of execution may be changed or interleaved without affecting the normal execution of subsequent operations. Those skilled in the art may also add or delete some operations without changing the core idea of the present disclosure and without obviously affecting the execution effect of the present disclosure.

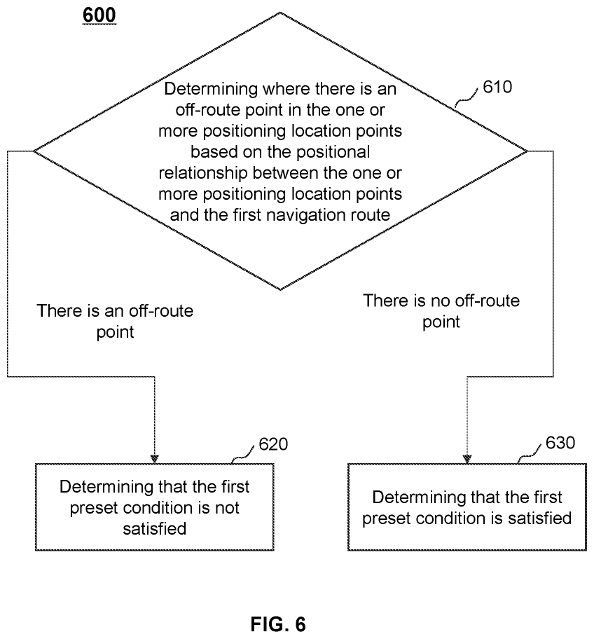

In some embodiments, the determination of whether the first preset condition is satisfied may be performed in various ways. In some embodiments, whether the first preset condition is satisfied may be determined based on operations described in FIG. 6. In some embodiments, whether the first preset condition is satisfied may be determined based on operations described in FIG. 15. In some embodiments, whether the first preset condition is satisfied may be determined by determining a similarity between the actual travel route of the object and the first navigation route during the traveling. It is understandable that other operations may be performed to determine whether the first preset condition is satisfied, which will not be described in detail in the present disclosure.

FIG. 6 is a flowchart illustrating an exemplary process for determining whether a first preset condition is satisfied according to some embodiments of the present disclosure. The process 600 may be performed to achieve the operation 520 described in FIG. 5. As shown in FIG. 6, the process 600 of the determination of whether the first preset condition is satisfied based on the positional relationship between one or more positioning location points and the first navigation route may include one or more of the following operations. In some embodiments, the process 600 may be performed by the processing device 400. Specifically, the process 600 may be executed by the judgement module 420.

In 610, the judgement module 420 may determine whether there is an off-route point in the one or more positioning location points based on the positional relationship between the one or more positioning location points and the first navigation route.

In this embodiment, the positional relationship between one or more positioning location points and the first navigation route may be distances between the positioning location points and the first navigation route. The off-route point may be a positioning location point that does not match the first navigation route. For example, the off-route point may be a positioning location point whose vertical distance from the first navigation route is greater than a preset distance, or the off-route point may be a positioning location point that is not located on a line segment corresponding to the first navigation route on a coordinate graph.

In 620, in response to determining that there is an off-route point in the one or more positioning location points, the judgement module 420 may determine that the first preset condition is not satisfied.

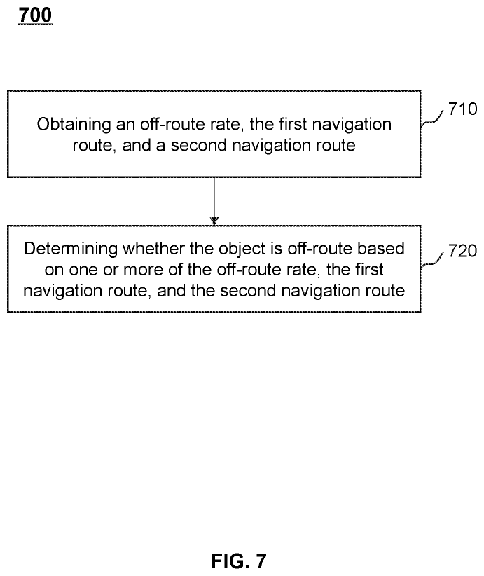

When there is an off-route point in the one or more positioning location points, it means that the object may be off-route, or the real-time travel route of the object begins to be inconsistent with the first navigation route. At this case, that the first preset condition is not satisfied may be determined, and continue to perform operation 710 described in FIG. 7 to further determine whether the object is off-route.

In 630, in response to determining that there is no off-route point in the one or more positioning location points, the judgement module 420 may determine that the first preset condition is satisfied.

When there is no off-route point in one or more positioning location points, it means that the object is unlikely to be off-route, or the real-time travel route of the object is consistent with the first navigation route, so no further determination operation needs to be performed.

FIG. 7 is a flowchart illustrating an exemplary process for determining whether an object is off-route according to some embodiments of the present disclosure. The process 700 may be performed to achieve the operation 530 described in FIG. 5. As shown in FIG. 7, the process 700 for determining whether an object is off-route based on information associated with the traveling of the object may include one or more of the following operations. In some embodiments, the process 700 may be performed by the processing device 400. Specifically, the process 700 may be performed by the determination module 430.

In 710, the processing device 400 may obtain an off-route rate, the first navigation route, and a second navigation route.

It can be understood that the off-route rate, the first navigation route, and the second navigation route all belong to the information associated with the traveling of the object. The off-route rate may indicate a likelihood of off-route for at least one positioning location point that deviates from the first navigation route. In some embodiments, the off-route rate may be a probability.

The second navigation route may be a new navigation route from the at least one positioning location point that deviates from the first navigation route to the first travel destination when the first preset condition is not satisfied. When the object deviates from the first navigation route from the first departure point, the second navigation route may be a new route from the first departure point to the first travel destination.

In some embodiments, the initial navigation trajectory (e.g., the first navigation route) may correspond to the initial navigation route generated according to the first departure point and the first travel destination of the initial object before the real-time navigation route changes. A secondary navigation trajectory may be a new route from the off-route position (e.g., the off-route point) to the first travel destination generated after the real-time navigation route changes.

The off-route rate may be obtained in several ways. In some embodiments, the off-route route may be obtained based on road condition information. For example, congestion information of multiple navigation routes between a positioning location point and the first travel destination may be obtained, and the off-route rate for the positioning location point may be determined based on the congestion information. For example, the off-route rate may be further determined based on degrees of congestion (e.g., in a percentage) of each navigation route and the first navigation route. Merely by way of example, a basic off-route rate (e.g., 20%) may be set. The basic off-route rate may be obtained based on historical navigation data of navigation software, or be manually set in advance and stored in the database, or be obtained by other ways. If the degree of congestion of a certain navigation route is lower than that of the first navigation route, the off-route rate may be increased on the basis of the basic off-route rate, for example, to 30%.

In other embodiments, the off-route rate may be determined based on historical travel routes associated with the first navigation route. The determination of the off-route rate may include the following operations: obtaining one or more historical travel routes associated with the first navigation route; and determining the off-route rate at the least one positioning location point that deviates from the first navigation route based on the one or more historical travel routes.

It can be understood that the historical travel route associated with the first navigation route may be a historical travel route that completely coincides with the first navigation route (i.e., the starting point and ending point are the same as the first navigation route), or be a historical travel route that partially overlaps with the first navigation route (e.g., the first navigation route is a portion of the historical travel route, the historical travel route is a portion of the first navigation route, or a portion of the historical travel route coincides with a portion of the first navigation route).

The historical travel routes associated with the first navigation route may be historical travel routes of different objects. There may be various methods for determining the historical travel routes associated with the first navigation route. In some embodiments, a historical travel route associated with the first navigation route may be determined based on a plurality of trajectory points on the first navigation route. For example, the coordinates of any 100 trajectory points on the first navigation route may be obtained, and a count of trajectory points that are located on the historical travel route among the 100 trajectory points on the first navigation route may be calculated. Count threshold may be set to 70 in advance. If the count of trajectory points that are located on the historical travel route among the 100 trajectory points is smaller than the count threshold, it is determined that the historical travel route is not associated with the first navigation route of current travel. If the count of trajectory points that are located on the historical travel route among the 100 trajectory points is greater than the count threshold, it is determined that the historical travel route is associated with the first navigation route of the current travel.

In other embodiments, similarities between the first navigation route and the historical travel routes may be calculated, and the historical travel routes whose similarity with the first navigation route are greater than a preset similarity threshold may be determined as the historical travel routes associated with the first navigation route. The historical travel routes associated with the first navigation route may also be determined in other manners, which will not be repeated in the present disclosure.

In some embodiments, the at least one positioning location point that deviates from the first navigation route may be the current positioning location point, and the off-route rate at the at least one positioning location point that deviates from the first navigation route may be the off-route of the current positioning location point. The off-route rate of the current positioning location point may indicate a likelihood (e.g., a possibility) of off-route for the current positioning location point.

The determination of the off-route rate at the least one positioning location point that deviates from the first navigation routes based on the one or more historical travel routes may include the following operations. One or more first historical travel routes that are off-route from the at least one positioning location point that deviates from the first navigation rout may be determine from the one or more historical travel routes. The off-route rate may be determined based on a quantitative relationship between the one or more first historical travel routes and the one or more historical travel routes.

The first historical travel routes may be historical travel routes that are off-route at at least one positioning location point (e.g., the current positioning location point). In some embodiments, the quantitative relationship between the first historical travel routes and the historical travel routes may be a ratio of a number of the first historical travel routes to a number of the historical travel routes, or a ratio of the number of the historical travel routes to the number of the first historical travel routes.

In other embodiments, the quantitative relationship between the first historical travel routes and the historical travel routes may be a quantitative relationship obtained by weighting count values of the first historical travel routes and count values of the historical travel routes. Specifically, weights may be assigned to the count value of each of the first historical travel routes and the count value of each of the historical travel routes when the number of the first historical travel routes and the number of historical travel routes are calculated. For example, weights (e.g., 1.2, 1.5, etc.) May be assigned to the count value of each first historical travel route and the count value of each historical travel route based on time. The farther the completion time of the first historical travel route and the historical travel route are from the current time, the lower the weight (e.g., 0.6, 0.8, etc.) Are assigned. Merely by way of example, the weights of five historical travel routes are respectively 0.6, 0.8, 1, 1.2, and 1.5. The historical travel routes corresponding to the weights of 0.6 and 1.2 are the first historical travel routes. Then the off-route rate may be: (0.6+1.2)/(0.6+0.8+1+1.2+1.5)≈0.439.

In some embodiments, the off-route rate may be determined in advance and stored in a storage device, and the off-route rate may be read directly from the storage device.

In some embodiments, the object may be off-route again based on the second navigation route. At this case, the processing device 400 or the object terminal may re-plan a navigation route to the first travel destination based on a location point where the off-route occurs again. For example, the processing device 400 or the object terminal may plan a fourth navigation route (also referred to as a third navigation trajectory in the present disclosure). At this case, one or more historical travel routes associated with the second navigation route may be obtained. The method for determining the historical travel routes associated with the second navigation route may be similar to the method for determining the historical travel routes associated with the first navigation route, and the descriptions of which are not repeated here. Then, an off-route rate at at least one positioning location point that deviates from the fourth navigation route may be determined based on the one or more historical travel routes associated with the second navigation route. The method for determining the off-route rate at the at least one positioning location point that deviates from the fourth navigation route may be similar to the method for determining the off-route rate at the at least one positioning location point that deviates from the first navigation route. During traveling, the object may be off-route for many times, and the off-route rate of each off-route point may be determined separately for subsequent calculation.

In some embodiments, in response to determining that the object is off-route, a new off-route rate at the at least one location point that deviates from the first navigation route may be determined based on one or more historical travel routes and the actual travel route of the object. The off-route rate at the at least one positioning location point may be updated using the new off-route rate. In this embodiment, the actual travel route of the object may be a combination of a route traveled on the first navigation route before the object is off-route and a route traveled along the second navigation route after the object is off-route. When the object deviates from the first navigation route from the first departure point, the actual travel route of the object may be a new navigation route (only include the second navigation route) from the departure point to the first travel destination. When the object is off-route again on the second navigation route, the actual travel route of the object may be a combination of a route traveled on the first navigation route before the object is firstly off-route, a route traveled on the second navigation route after the object is firstly off-route and before the object is secondly off-route, and a route traveled on a new navigation route determined by the location point when the object is secondly off-route and the first travel destination after the object is secondly off-route.

In 720, the processing device 400 may determine whether the object is off-route based on one or more of the off-route rate, the first navigation route, and the second navigation route.

The processing device 400 may determine whether the object is off-route based on the off-route rate, the first navigation route or the second navigation route. The processing device 400 may also determine whether the object is off-route based on a combination of any two of the off-route rate, the first navigation route, and the second navigation route or a combination of the off-route rate, the first navigation route, and the second navigation route.

In some embodiments, whether the object is off-route may be determined according to the off-route rate. Whether the object is off-route may be determined by setting a preset off-route threshold and comparing the off-route rate with the preset off-route threshold. In some embodiments, in response to determining that the off-route rate is smaller than a preset off-route threshold, that the object is off-route may be determined. For example, if the off-route rate of a certain positioning location point that deviates from the first navigation route is 60%, and the preset off-route threshold is 70%, it is determined that the object is off-route.

In other embodiments, it may be determined whether the object is off-route according to the first navigation route and the second navigation route. Specifically, a route (i.e., a third navigation route) from the at least one positioning location point that deviates from the first navigation route to the first travel destination in the first navigation route be obtained. First information related to completing the third navigation route (e.g., predicted travel time information, predicted fuel consumption information, path length information, or the like, or any combination thereof) may be obtained. Second information related to the second navigation route (e.g., predicted travel time information, predicted fuel consumption information, path length information, or the like, or any combination thereof) may be obtained. Then the first information may be compared with the second information to determine whether the object is off-route. For example, a fuel consumption value in the second information is greater than a fuel consumption value in the first information, and a difference between the fuel consumption value in the second information and the fuel consumption value in the first information is greater than a preset fuel consumption difference, it can be determined that the object is off-route. If a path length in the second information of the second navigation route is greater than a path length in the first information of the third navigation route, it is determined that the object is off-route.

In some embodiments, whether the object is off-route may be jointly determined according to the off-route rate and the relationship between the second navigation route and the third navigation route, thereby reducing the possibility of misjudging of that the object is off-route. The relationship between the second navigation route and the third navigation route may be determined based on the first information and the second information. For example, whether the off-route rate at the at least one positioning location point that deviates from the first navigation route is smaller than the preset off-route threshold, and the relationship between the path length in the second information and the path length in the first information may be determined simultaneously. If the off-route rate at the at least one positioning location point that deviates from the first navigation route is smaller than the preset off-route threshold, and the path length in the second information of the second navigation route is greater than the path length in the first information of the third navigation route, it is determined that the object is off-route.

In some embodiments, the processing device 400 may perform one or more of the following operations. In response to determining that the object is off-route, the processing device 400 may determine a second historical travel route that is not off-route at the at least one positioning location point that deviates from the first navigation route from the one or more historical travel routes. The processing device 400 may determine a route similarity between the second navigation route and the second historical travel route. The processing device 400 may send the route similarity to the object.

It can be understood that there may be various methods for calculating the route similarity between the second navigation route and the second historical travel route. For example, trajectory points may be selected on the second navigation route and the second historical travel route at preset time intervals, respectively, and the route similarity between the second navigation route and the second historical travel route may be determined based on coordinates of the trajectory points. As another example, road bifurcation points on the second navigation route and the second historical travel route may be obtained first, and then one or more trajectory points at a preset time interval after each road bifurcation point on the second navigation route and the second historical travel route may be obtained, and then the route similarity between the second navigation route and the second historical travel route may be determined based on coordinates of the trajectory points after the road bifurcation points. In some embodiments, the route similarity may be sent to the object (e.g., a terminal used by the object, a vehicle-mounted navigation terminal, etc.) Together with the off-route prompt. In other embodiments, the route similarity may be sent as a way of off-route prompt.

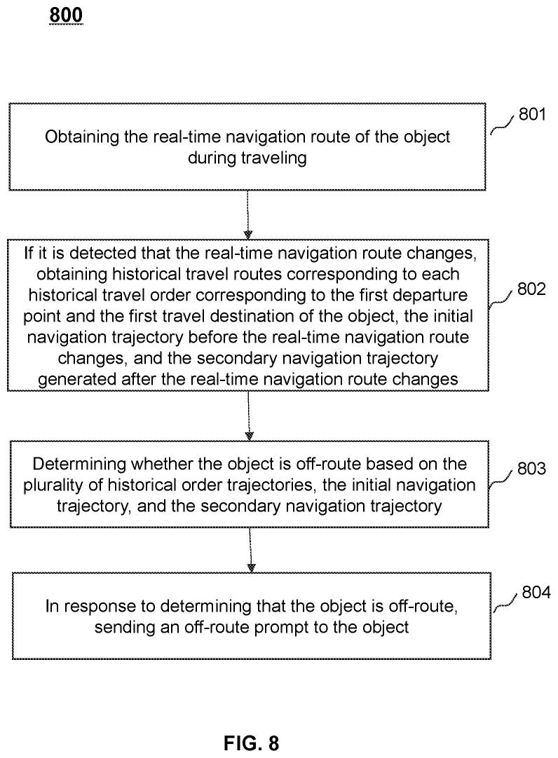

Referring to FIG. 8, FIG. 8 is a flowchart illustrating an exemplary off-route identification process according to some embodiments of the present disclosure. FIG. 8 may be an embodiment of the operations described in FIG. 5. The operations described in FIG. 8 may be executed by one or more processors in the server, the service request terminal and/or the service provider terminal in the above off-route identification system. The process 800 may include the following operations.

In 801, the real-time navigation route of the object during traveling may be obtained.

Further, if the first travel destination is temporarily changed when the object travels according to the initial navigation route, accordingly, the initial navigation route cannot simply be regarded as a route generated based on the first departure point and the changed first travel destination, but initial navigation route may be a combination of a route between the first departure point and the real-time location of the object when the first travel destination is changed, and a route between the real-time location of the object when the first travel destination is changed and the changed first travel destination.

In 802, if it is detected that the real-time navigation route changes, historical travel routes corresponding to each historical travel order corresponding to the first departure point and the first travel destination of the object, the initial navigation trajectory before the real-time navigation route changes, and the secondary navigation trajectory generated after the real-time navigation route changes may be obtained. The method for detecting whether the real-time navigation route changes may be similar to the method for determining whether the first preset condition is satisfied in operation 520.

In this operation, if it is detected that the real-time navigation route changes during the traveling of the object, the first departure point and the first travel destination of the traveling of the object may be obtained first. Then the departure point and the destination of the travel order, a plurality of historical travel orders corresponding to the first departure point and the first travel destination respectively, and a historical order trajectory corresponding to each historical travel order (e.g., the historical travel route described above) may be obtained. Then the corresponding initial navigation trajectory before the real-time navigation route changes, and the secondary navigation trajectory generated after the real-time navigation route changes may be obtained.

In 803, whether the object is off-route may be determined based on the plurality of historical order trajectories, the initial navigation trajectory, and the secondary navigation trajectory.

In this operation, after the plurality of historical order trajectories, the initial navigation trajectory, and the secondary navigation trajectory are obtained, the plurality of historical order trajectories, the initial navigation trajectory, and the secondary navigation trajectory be used for judgment to determine whether the object is off-route.

Specifically, to determine whether the object is off-route based on the plurality of historical order trajectories, the initial navigation trajectory, and the secondary navigation trajectory, the off-route position of the object when the real-time navigation route changes may be obtained first. Due to that the position where the off-route occurs is very close to a position immediately before the off-route occurs, them can be considered to be a same position, that is, the off-route position may be considered as the real-time location of the object on the initial navigation route at a previous moment when the object is off-route according to the initial navigation route. That is, the off-route position here may be the current positioning location point obtained during the traveling of the object when the first preset condition is not satisfied.

Then, the off-route rate at the off-route position may be determined according to the obtained plurality of historical order trajectories by calculating or querying basic road network data, etc., and the off-route rate may be compared with the preset off-route threshold. If the off-route rate is smaller than the preset off-route threshold, and the path length of the secondary navigation trajectory is greater than a path length of a route from the off-route position to the first travel destination in the initial navigation trajectory, it is determined that the object is off-route.

Wherein, the basic road network data may refer to road network map data in which each road information, each road point information, or the like, are stored. Correspondingly, the way of querying the basic road network data may refer to querying the off-route rates corresponding to the plurality of historical order trajectories at the off-route position from pre-calculated data corresponding to each route point and each historical order trajectory recorded in the basic road network data using the plurality of historical order trajectories, so that some data processing process may be omitted, thereby reducing data processing count and processing time.

Further, determining the off-route rates at the off-route position based on the plurality of historical order trajectories may include the following operations. According to the order information of each historical travel order corresponding to the departure point and the first travel destination, the plurality of historical order trajectories may be screened to determine historical order trajectories with off-route at the off-rout position from the plurality of historical order trajectories. A quantity ratio between historical order trajectories with off-route at the off-rout position and the plurality of historical order trajectories may be calculated according to a count of historical order trajectories with off-route at the off-rout position and a count of the plurality of historical order trajectories, and the quantity ratio may be determined as the off-rout rate at the off-rout position.

In 804, in response to determining that the object is off-route, an off-route prompt may be sent to the object.

In this operation, in response to determining that the object is off-route, an off-route prompt may be sent to the object to remind the object to adjust in time.

Specifically, in response to determining that the object is off-route, a historical order trajectory without off-route at the off-route position among the plurality of historical order trajectories may be determined. Then difference between the secondary navigation trajectory and the historical order trajectory without off-route may be determined. The route similarity between the secondary navigation trajectory and the historical order trajectory without off-route may be used to determine the degree of off-route. The route similarity between the secondary navigation trajectory and the historical order trajectory without off-route and the off-route prompt may be sent to the object.

Among them, the historical order trajectory without off-route may have a plurality of routes, and may include the above-mentioned initial navigation trajectory.

Since there are a plurality of historical order trajectories without off-route, and each historical order trajectory without off-route may be considered to be substantially consistent. The route similarity between the secondary navigation trajectory and the historical order trajectory without off-route may be the similarity between the secondary navigation trajectory and any one of the historical order trajectories without off-route, or an average of the similarities between the secondary navigation trajectory and the historical order trajectories.

According to the off-route identification process provided by the embodiments of the present disclosure, the real-time navigation route of the object during traveling may be obtained; if it is detected that the real-time navigation route changes, historical travel routes corresponding to each historical travel order corresponding to the first departure point the first travel destination of the object may be obtained, the initial navigation trajectory before the real-time navigation route changes, and the secondary navigation trajectory generated after the real-time navigation route changes; whether the object is off-route may be determined based on the plurality of historical order trajectories, the initial navigation trajectory, and the secondary navigation trajectory; in response to determining that the object is off-route, an off-route prompt may be sent to the object.

By combining the historical order trajectories and the navigation routes before and after the real-time navigation route changes, the off-route situation of the object may be identified, so that the off-route situation may be found in time during traveling, and the object can be reminded, which have improved real-time performance and the accuracy of off-route recognition, thereby effectively reducing the probability of detours and energy consumption due to off-route.

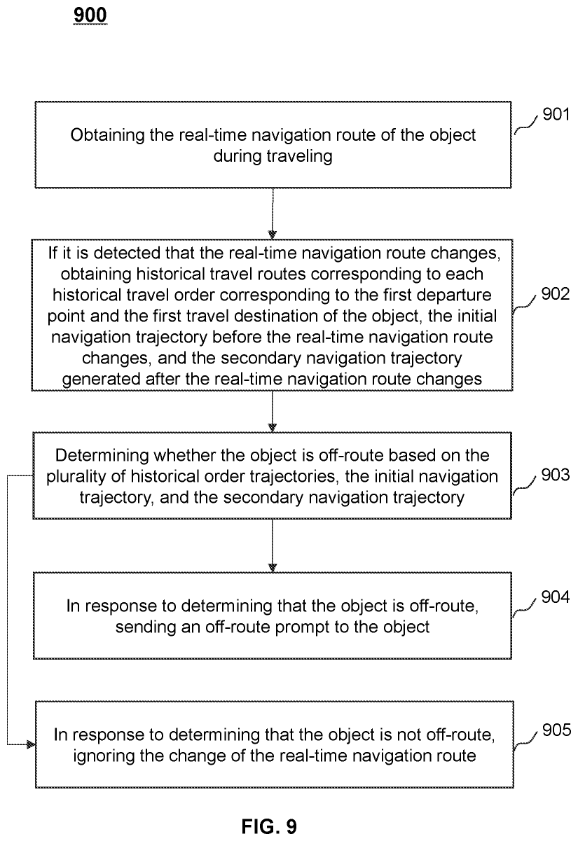

Referring to FIG. 9, FIG. 9 is a flowchart illustrating an exemplary off-route identification process according to some embodiments of the present disclosure. The operations described in FIG. 9 may be executed by one or more processors in the server, the service request terminal and/or the service provider terminal in the above off-route identification system. The process 900 may include the following operations.

In S 901, the real-time navigation route of the object during travel may be obtained.

In 902, if it is detected that the real-time navigation route changes, historical travel routes corresponding to each historical travel order corresponding to the first departure point and the first travel destination of the object may be obtained, the initial navigation trajectory before the real-time navigation route changes, and the secondary navigation trajectory generated after the real-time navigation route changes.

In 903, whether the object is off-route may be determined based on the plurality of historical order trajectories, the initial navigation trajectory, and the secondary navigation trajectory.

In 904, in response to determining that the object is off-route, an off-route prompt may be sent to the object.

The description of operations 901 to 904 may refer to the descriptions of operations 801 to 804, and the same technical effect can be achieved, which is not repeated here.

In 905, in response to determining that the object is not off-route, the change of the real-time navigation route may be ignored.

In this operation, if it is determined that the object is not off-route, the change of the real-time navigation route may be ignored, and it is considered that there is no problem during the traveling of the object.

In some embodiments, after whether the object is off-route is determined based on the plurality of historical order trajectories, the initial navigation trajectory, and the secondary navigation trajectory, the off-route identification process may include the following operations.

In response to determining that the object is off-route, the off-route rate at the off-route position of the object for this traveling may be determined based on plurality of historical order trajectories and the actual route of the object that is traveling along the real-time navigation route, and use the determined off-route rate to update the off-route rate in the basic road network data for travels of the object prior to this traveling of the object.

In this operation, the basic road network data stores relevant information of each road, relevant information of each road point, etc., and the relevant information may be queried from the basic road network data for access. Therefore, the basic road network data also needs to be updated in time. Correspondingly, if the object is off-route, due to the off-route at the off-route position, the actual route of the object that is traveling according to the real-time navigation route also belongs to one historical order trajectory with off-route at the off-route position in the plurality of historical order trajectories. Then the plurality of historical order trajectories and the actual route may be used to determine the off-route rate at the off-route position for this traveling of the object by calculation and other operations. The determined off-route rate may be used to update the basic road network data to replace the off-route rate for travels prior to this traveling of the object in the basic road network data with the determined off-route rate.

Wherein, the actual route may include a route between the object traveling from the first departure point to the off-route position in the initial navigation trajectory and the secondary navigation trajectory.

In some embodiments, before operation 901 is performed, the off-route identification process may further include the following operations.

During the traveling of the object, in response to detecting that the object accepts a joint travel request, a second departure point and a second travel destination of the joint travel request, and a current positioning location point of the object may be obtained. A first departure point and a first travel destination of the object corresponding to each segment of the travel route may be determined based on the second departure point and the second travel destination, the current positioning location point of the object, and the first travel destination.

In this operation, during the traveling of the object, there may be situations such as someone carpooling, or someone needing to take a ride. In these cases, the travel of the object may be changed during travelling, which is prone to misjudgment of off-route. Therefore, during the traveling of the object, if it is detected that the object accepts a joint travel request, such as someone carpooling, taking a ride, or needing to pick up people temporarily, etc., the second departure point and the second travel destination of the joint travel request, and the real-time location when the subject accepts the joint travel request may be obtained. Then, the order of arrivals may be obtained by sorting the second departure point, the second travel destination, the real-time location, and the first travel destination of the object, so as to divide the travel into multiple segments to obtain multiple segments travel routes. The first departure point and the first travel destination of each segment travel route of multiple segments travel routes may be determined.

Specifically, the first departure point and the first travel destination of the object in each segment of the travel route may be determined based on the second departure point, the second travel destination, the real-time location, and the first travel destination of the object may include the following operations. A travel order (i.e., which place to reach first, and which place to arrive later) of the object from the real-time location to the second departure place, the second travel destination and the first travel destination in turn may be determined in the order of arrival by geographic locations, or the convenience of reaching each geographic location based on the geographic location of the second departure point, the geographic location of the second travel destination, the geographic location of the real-time location, and the geographic location of the first travel destination. Then, according to the travel order, each adjacent two locations may be determined as the departure point and destination of each segment route, the navigation route between each adjacent two locations, and the real-time navigation route corresponding to the navigation route may be determined.

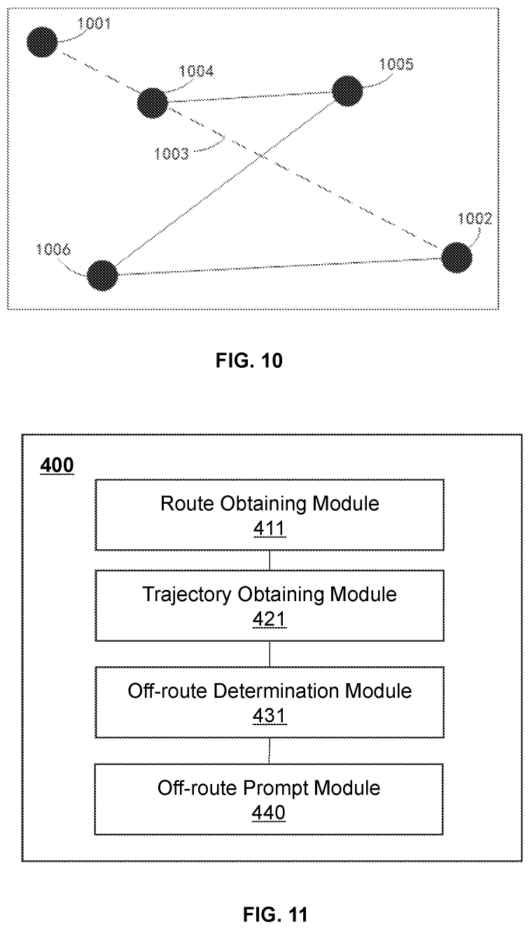

For example, FIG. 10 is a schematic diagram illustrating exemplary changes of the real-time navigation route after the object accepts the joint travel request according to some embodiments of the present disclosure. As shown in FIG. 10, for a first departure point 1001 and a first travel destination 1002 of this travel of the object, the object travels in a real-time navigation route 1003 corresponding to the first departure point 1001 and the first travel destination 1002, and a joint travel request of a second departure point 1005 and a second travel destination 1006 is accepted when the subject travels to the real-time location 1004. It can be sorted according to the geographical location of the real-time location 1004, the geographical location of the first travel destination 1002, the geographical location of the second departure point 1005, the geographical location of the second travel destination 1006, and other factors such as a travel demand, etc. For example, the object may go to the second departure point 1005 to pick up some person, then send the person to the second travel destination 1006, and finally go to the first travel destination 1002. In this way, the remaining travel may be divided into three segments, i.e., a segment from the real-time location 1004 to the second departure point 1005, a segment from the second departure point 1005 to the second travel destination 1006, and a segment from the second travel destination 1006 to the first travel destination 1002. Each segment route may be used as a separate real-time navigation route. The object may travel according to the navigation route corresponding to each real-time navigation route, and the off-route in each real-time navigation route may be detected.

Correspondingly, the obtaining of the real-time navigation route of the object during traveling may include: obtaining the real-time navigation route determined by the object in each segment of the travel route based on the first departure point and the first travel destination.

In this operation, when there are multiple travel routes, off-route identification may be performed for each travel route respectively, that is, each travel route of the object may be obtained, and the first departure point and first travel destination of each travel route m may be obtained based on the first travel route. In this way, the real-time navigation route may be accurately determined, which may effectively reduce the probability of misjudgment for off-route.

According to the off-route identification process provided by the embodiments of the present disclosure, the real-time navigation route of the object during traveling may be obtained; if it is detected that the real-time navigation route changes, historical travel routes corresponding to each historical travel order corresponding to the first departure point the first travel destination of the object may be obtained, the initial navigation trajectory before the real-time navigation route changes, and the secondary navigation trajectory generated after the real-time navigation route changes; whether the object is off-route may be determined based on the plurality of historical order trajectories, the initial navigation trajectory, and the secondary navigation trajectory; in response to determining that the object is off-route, an off-route prompt may be sent to the object; in response to determining that the object is not off-route, the change of the real-time navigation route may be ignored.

By combining the historical order trajectories and the navigation routes before and after the real-time navigation route changes, the off-route situation of the object may be identified, so that the off-route situation may be found in time during traveling, and the object can be reminded, which have improved real-time performance and the accuracy of off-route identification, thereby effectively reducing the probability of detours and energy consumption due to off-route.

According to the off-route identification process provided by the embodiments of the present disclosure, the real-time navigation route of the object during traveling may be obtained; if it is detected that the real-time navigation route changes, historical travel routes corresponding to each historical travel order corresponding to the first departure point the first travel destination of the object may be obtained, the initial navigation trajectory before the real-time navigation route changes, and the secondary navigation trajectory generated after the real-time navigation route changes; whether the object is off-route may be determined based on the plurality of historical order trajectories, the initial navigation trajectory, and the secondary navigation trajectory; in response to determining that the object is off-route, an off-route prompt may be sent to the object.

By combining the historical order trajectories and the navigation routes before and after the real-time navigation route changes, the off-route situation of the object may be identified, so that the off-route situation may be found in time during traveling, and the object can be reminded, which have improved real-time performance and the accuracy of off-route recognition, thereby effectively reducing the probability of detours and energy consumption due to off-route.

According to another aspect of the present disclosure, an electronic device may be provided. The electronic device may include a processor, a storage medium and a bus. The storage medium may store machine-readable instructions executable by the processor. When the electronic device is operating, the processor may communicate with the storage medium via the bus, and the processor executes machine-readable instructions to perform the process for off-route identification as described above.

According to another aspect of the present disclosure, a computer-readable storage medium may be provided. The computer-readable storage medium may store computer programs, wherein when the computer programs are executed by a processor, the process for off-route identification may be performed.

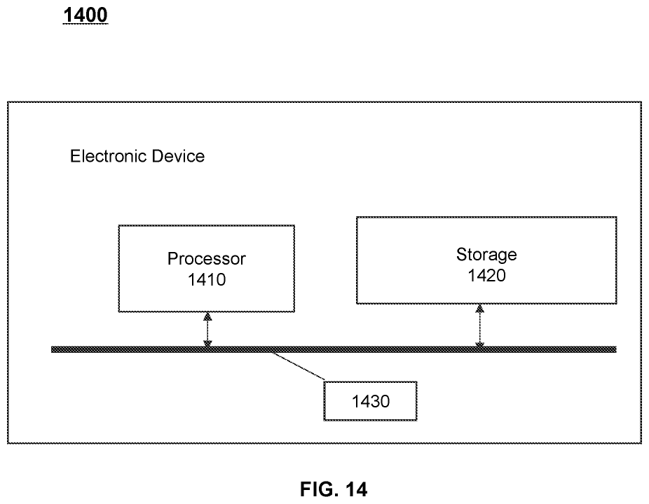

Referring to FIG. 14, FIG. 14 is a schematic diagram illustrating an exemplary electronic device according to some embodiments of the present disclosure. As shown in FIG. 14, the electronic device 1400 may include a processor 1410, a storage 1420, and a bus 1430.

The storage 1420 may store machine-readable instructions executable by the processor 1410. When the electronic device 1400 is operating, the processor 1410 may communicate with the storage 1420 via the bus 1430. When machine-readable instructions are executed by the processor 1410, the process for off-route identification described in FIG. 8 and FIG. 9 may be performed, and the descriptions of which are not repeated here.

According to some embodiments of the present disclosure, a computer-readable storage medium may be provided. The computer-readable storage medium may store computer programs, wherein when the computer programs are executed by a processor, the process for off-route identification described in FIG. 8 and FIG. 9 may be performed, and the descriptions of which are not repeated here.

In some embodiments of the present specification, certain specific nouns can include information related to the nouns. For example, a positioning location point may include information of the positioning location point. Correspondingly, in some embodiments, operations involving specific nouns are actually operations performed on information related thereto, which will not be described in detail later.

FIG. 15 is a flowchart illustrating an exemplary process for determining whether a first preset condition is satisfied according to some embodiments of the present disclosure. As shown in FIG. 15, the process 1500 may include one or more of the following operations. In some embodiments, the process 1500 may be performed by the processing device 400. Specifically, the process 1500 may be performed by the judgement module.

In 1510, the judgement module 420 may determine, based on a positional relationship between one or more positioning location points and a first navigation route, whether there is a mapping location point of a current positioning location point on the first navigation route.

In some embodiments, the mapping location point may be a location point on the first navigation route that has a mapping relationship with the one or more positioning location points. In some embodiments, the mapping relationship may be a projection of a positioning location point on the first navigation route along a certain direction (e.g., a direction with a closest distance to the first navigation route, a direction perpendicular to a traveling direction of an object, etc.). In some embodiments, a projected point of a positioning location point on the first navigation route along the direction may be regarded as a mapping location point only if one or more conditions are satisfied. The conditions may be related to a distance between the positioning location point and the corresponding projection point. For example, if the distance between the positioning location point and the corresponding projection point is smaller than or equal to a distance threshold, the projection point may be regarded as a mapping location point. During a traveling of an object, when the positioning location point of the object is on the first navigation route or is close to the first navigation route, the corresponding mapping location point may be determined for the positioning location point of the object on the first navigation route, which may form a binding relationship with the positioning location point.

In some embodiments, the one or more positioning location points may include at least the current positioning location point. In some embodiments, the object may be a service provider terminal. The first navigation route may be a navigation route corresponding to the current order of the service. The current positioning location point may be a positioning location point reported by the service provider terminal at the time that matches the current time when the current order is served. The time that matches the current time may include: the current time, a time closest to the current time (e.g., a previous time point of the current time, a next time point of the current time, etc.), a time with a time difference smaller than a threshold value from the current time, etc. In other embodiments, the one or more positioning location points may include a previous positioning location point and/or a subsequent positioning location point of the current positioning location point. In some other embodiments, the one or more positioning location points may also include other positioning location points acquired during the traveling of the object. In operation 1510, it is also possible to further determine whether there are mapping location points of other positioning location points on the first navigation route.

The positional relationship may be the same as the specific positional relationship (e.g., the distance) described in operation 610, or may be different from the positional relationship described in operation 610.

The judgement module 420 may use various methods to determine whether there is a mapping location point of the current positioning location point on the first navigation route. In some embodiments, a circle may be drawn with a preset radius by taking the current positioning location point as the center of the circle, and if the circle has an intersection with the first navigation route, there is a mapping location point of the current positioning location point. As another example, if a distance (e.g., a vertical distance, a straight-line distance, etc.) Between the current positioning location point and the first navigation route is greater than a preset distance, there is a mapping location point of the current positioning location point.

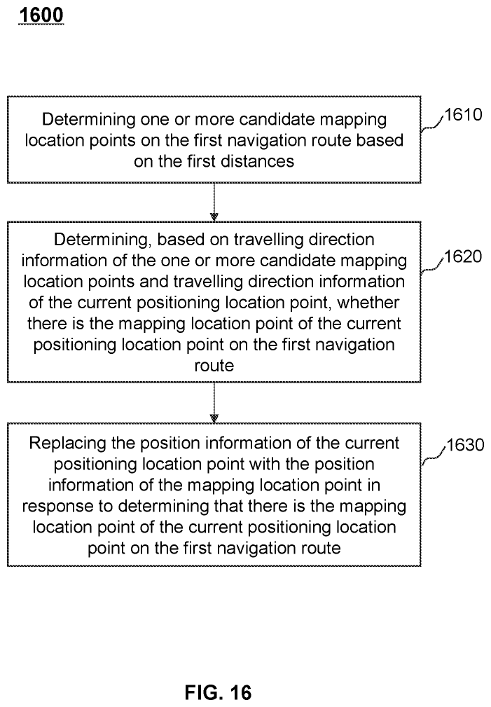

In some embodiments, the positional relationship between the one or more positioning location points and the first navigation route may include first distances between the one or more positioning location points and the first navigation route, and the first distances may be determined based on position information of the one or more positioning location points. The judgement module 420 may determine whether there is a mapping location point of the current positioning location point on the first navigation route based on the first distances. More descriptions for the determining of whether there is a mapping location point of the current positioning location point on the first navigation route based on the first distances may be found in FIG. 16 and the descriptions thereof, and the descriptions of which are not repeated here.

A first distance may refer to an amount reflecting a distance between a positioning location point and the first navigation route. There are various methods for calculating the first distances. For example, the first distances may include a vertical distance from each of the one or more positioning location points to the first navigation route, or a vertical distance of each of the one or more positioning location points to the first navigation route along in a certain direction (e.g., a direction perpendicular to the traveling direction).

Merely by way of example, if the object is a drone that performs an aerial photography mission or a delivery mission, a location of the current positioning location point (also referred as to a current location) may be a position reported in real time by a positioning device on the drone. The first navigation route may be a preset aerial photography route or a delivery route. The judgement module 420 may determine whether there is a mapping location point of the current positioning location point on the first navigation route based on the positional relationship between the current positioning location point of the drone and the first navigation route. For example, if a height of the current positioning location point of the drone is greater than a maximum height of the trajectory points on the first navigation route by a certain threshold value, it is determined that there is no mapping location point of the current positioning location point on the first navigation route. As another example, if a minimum distance between the current positioning location point of the drone and the trajectory points on the first navigation route is smaller than a certain threshold, it is determined that there is a mapping location point of the current positioning location point on the first navigation route.

As another example, if the object is an entity being transported (e.g., a merchandise, a takeout, a cargo, a driver, a passenger, a pet, etc.), the location of the current location point (also referred as to the current location) may be a location reported in real-time by a mobile phone, a wristband, a watch, a locator, and other devices carried by the entity or configured on the entity. The first navigation route may be a preset transportation route. The judgement module 420 may determine whether there is a mapping location point of the current positioning location point on the first navigation route based on the positional relationship between the current positioning location point of the entity and the first navigation route. For example, if a signal strength of the current positioning location point of the entity is smaller than the minimum signal strength of the trajectory points on the first navigation route by a certain threshold, it is determined that there is no mapping location point of the current positioning location point on the first navigation route. As another example, if the minimum distance from the current positioning location point of the entity to the trajectory points on the first navigation route is smaller than a certain threshold, it is determined that there is a mapping location point of the current positioning location point on the first navigation route.

In 1520, the judgement module 420 may determine that the first preset condition is not satisfied in response to determining that there is no mapping location point of the current positioning location point on the first navigation route.

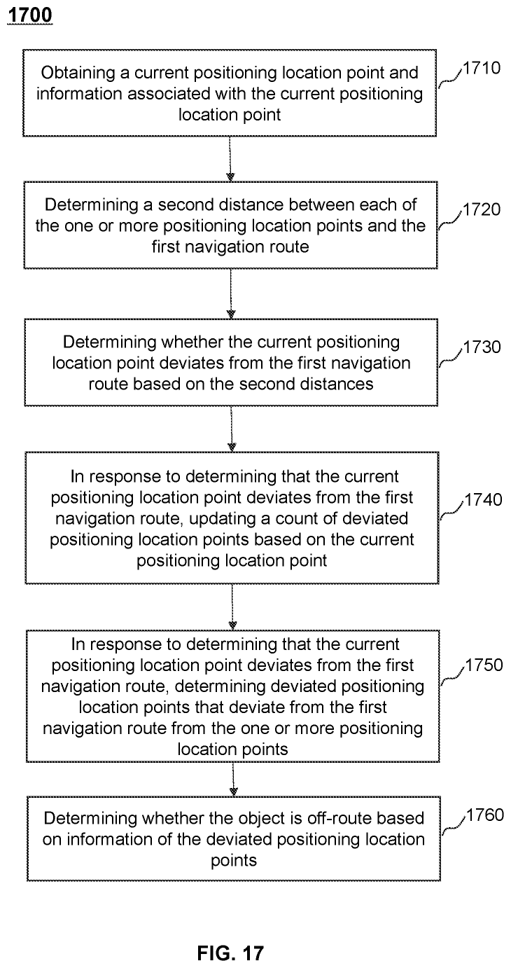

If there is no mapping location point of the current positioning location point on the first navigation route, it means that the object may be off-route, or the real-time travel route of the object does not match the first navigation route. In this case, that the first preset condition is not satisfied may be determined, and a process 1700 described in FIG. 17 may be performed to further determine whether the object is off-route.

In 1530, the judgement module 420 may determine that the first preset condition is satisfied in response to determining that there is a mapping location point of the current positioning location point on the first navigation route.

If there is a mapping location point of the current positioning location point on the first navigation route, it means that the object is unlikely to be off-route, or the real-time travel route of the object is coincided with the first navigation route, so no further determination process needs to be performed.

Based on the first distances, the processing device may use various methods to determine whether there is a mapping location point of the current positioning location point on the first navigation route.

In some embodiments, the first distances may be a vertical distance from each positioning location point to the first navigation route. The determination of whether there is a mapping location point of the current positioning location point on the first navigation route based on the first distances may include the following operations. An average vertical distance between the one or more positioning location points and the first navigation route may be determined based on the first distance between the each of the one or more positioning location points and the first navigation route. Whether there is the mapping location point of the current positioning location point on the first navigation route may be determined based on the average vertical distance and a vertical distance from the current positioning location point to the first navigation route. For example, in response to determining that the vertical distance from the current positioning location point to the first navigation route is greater than the average vertical distance, it is determined that there is no mapping location point of the current positioning location point on the first navigation route. In response to determining that the vertical distance of the current positioning location point to the first navigation route is less than or equal to the average vertical distance, it is determined that there is a mapping location point of the current positioning location point on the first navigation route. It can be understood that, in this embodiment, the average vertical distance may also be replaced by an average value of other types of distances, or replaced by a weighted average vertical distance.

It should be noted that the weighted average vertical distance may be determined according to one or more of the following operations. In operation 1, the vertical distance from each positioning location point to the first navigation route may be calculated. In operation 2, different weights may be set for the vertical distance between each positioning location point obtained in operation 1 and the first navigation route. The weights may be related to distances between the positioning location points and the current positioning location point. For example, the farther a positioning location point is from the current positioning location point, the smaller the weight of the positioning location point is, the smaller the weight may be. The weights may also be related to the traveling directions of the object at the positioning location points. For example, the smaller an angle between the traveling directions corresponding to a positioning location point and the current positioning location point is, the greater the weight of the positioning location point may be. The weights may also be related to the signal strengths at the positioning location points. For example, the greater the signal strength at a positioning location point, the greater the weight of the positioning location point may be. In operation 3, a weighted average vertical distance may be obtained according to the vertical distance between each positioning location point and the first navigation route and its weight.

In some embodiments, according to the operations described in FIG. 16, it can be determined whether there is a mapping location point of the current positioning location point on the first navigation route based on the first distances.

FIG. 16 is a flowchart illustrating an exemplary process for determining whether there is a mapping location point according to some embodiments of the present disclosure. As shown in FIG. 16, the process 1600 may include one or more of the following operations. In some embodiments, the process 1600 may be performed by the processing device 400.

In 1610, the judgement module 420 may determine one or more candidate mapping location points on the first navigation route based on the first distances.

The candidate mapping location points may be trajectory points on the first navigation route that are likely to be determined as mapping location points. There may be various methods for determining one or more candidate mapping location points on the first navigation route based on the first distances. In some embodiments, the vertical distance from the current positioning location point to the first navigation route may be compared with the average vertical distance, and the candidate mapping location points may be positioning location points whose distances from the current positioning location point are smaller than the average vertical distance among the trajectory points on the first navigation route. In other embodiments, the candidate mapping location points may be positioning location points whose distances from the current positioning location point are equal to the average vertical distance among the trajectory points on the first navigation route. In some embodiments, if the vertical distance from the current positioning location point to the first navigation route is greater than the average vertical distance, it is determined that there is no mapping location point of the current positioning location point on the first navigation route.

In other embodiments, a circle may be drawn on a map with the current positioning location point as the center and the average vertical distance (e.g., the weighted average vertical distance) as the radius, and the trajectory points on the first navigation route within the circle may be determined as candidate mapping location point.

In some embodiments, whether there is a mapping location point of the current positioning location point on the first navigation route may be determined based on the position information of the current positioning location point and the position information of the candidate mapping location points. For example, multiple initial trajectory points may be selected on the first navigation route, and the distances between the current positioning location point and the multiple initial trajectory points may be calculated and be sorted. Then a preset count (e.g., 3, 5, etc.) Of initial trajectory points with a closest distance may be selected as candidate mapping location points.

In 1620, the judgement module 420 may determine, based on travelling direction information of the one or more candidate mapping location points and travelling direction information of the current positioning location point, whether there is the mapping location point of the current positioning location point on the first navigation route.

In some embodiments, the information of the current positioning location point may include position information (e.g., a coordinate), travelling direction information (e.g., a direction angle), or the like. The direction angle of the current positioning location point may be an angle formed between the traveling direction and a preset direction (e.g., due north, due south, etc.). The information of the candidate mapping location points may include position information (e.g., coordinates) and direction information (e.g., direction angles). The direction angle of a candidate mapping location point may be an angle formed between a tangent of the first navigation route at the location of the candidate mapping location point and a preset direction (e.g., due north, due south, etc.). Therefore, it can be further determined whether there is a mapping location point of the current positioning location point on the first navigation route based on the information of the current positioning location point and the information of the candidate mapping location points.

In other embodiments, it may be determined whether there is a mapping location point of the current positioning location point on the first navigation route based on the traveling direction information of one or more candidate mapping location points and the travelling direction information of the current positioning location point.

In some embodiments, the determination may be made based on the direction angles of one or more candidate mapping location points and the direction angle of the current positioning location point. For example, whether there is at least one candidate mapping location point whose direction angle matches the direction angle of the current positioning location point may be determined from the one or more candidate mapping location points. In response to determining that there is at least one candidate mapping location point whose direction angle matches the direction angle of the current positioning location point, a candidate mapping location point corresponding to a direction angle that matches the direction angle of the current positioning location point may be designated as the mapping location point. In some embodiments, that the direction angle of a candidate mapping location point matches the direction angle of the current positioning location point may be understood as a difference between the direction angle of a candidate mapping location point and the direction angle of the current positioning location point is relatively small (e.g., smaller than a preset angle threshold).

In some embodiments, various methods can be used to determine whether the direction angles of the candidate mapping location points match the direction angle of the current positioning location point. For example, if the difference between the direction angle of a candidate mapping location point and the direction angle of the current positioning location point is smaller than a preset angle threshold (e.g., 10°, 20°, etc.), it is considered that the direction angle of the candidate mapping location point matches the direction angle of the current positioning location point. If a vehicle speed of the object at the current positioning location point is too fast, such as exceeding a preset vehicle speed threshold (e.g., 80 km/h), the accuracy of the direction angle collected at this time may be low, and the preset angle threshold may be appropriately increased, such as increased by 2°, 5°, etc.

In 1630, the position information of the current positioning location point may be replaced with the position information of the mapping location point in response to determining that there is the mapping location point of the current positioning location point on the first navigation route. Specifically, the operation 1630 may be performed by an information replacing module.

In some embodiments, the method for replacing the position information of the current positioning location point with the position information of the mapping location point may be to replace the coordinates of the current positioning location point with the coordinates of the mapping location point. When a traveling trajectory of a vehicle driven by a service provider is displayed on an interface (e.g., an interface of a service request terminal held by a service requester), the mapping location point may be displayed instead of displaying the current positioning location point. The traveling trajectory of the vehicle driven by the service provider displayed on the service request terminal held by a service requester may be still on the first navigation route.

In some embodiments, the information associated with the traveling of the object may include at least information of one or more positioning location points. The determining of whether the object is off-route based on the information associated with the traveling of the object may include determining whether the object is off-route based at least on the information of one or more positioning location points.

FIG. 17 is a flowchart illustrating an exemplary process for determining whether an object is off-route according to some embodiments of the present disclosure. As shown in FIG. 17, the process 1700 may include one or more of the following operations. In some embodiments, the process 1700 may be performed by the processing device 400. Specifically, the process 1700 may be performed by the determination module 430.

In 1710, the processing device 400 may obtain a current positioning location point and information associated with the current positioning location point.

In operation 1710, the information associated with the current positioning location point may include a coordinate of the current positioning location point, a coordinate of a previous positioning location point of the current positioning location point and/or an acquisition time interval between the current positioning location point and the previous positioning location point. The information of the one or more positioning location points may include a precision factor and a coordinate of each of the one or more positioning location points.

In some embodiments, a speed threshold may be set according to an average speed value of the object from the previous positioning location point to the current positioning location point, to determine whether the current positioning location point is a bad point. In response to determining that the current positioning location point is a bad point, the current positioning location point may be deleted.

Specifically, the average speed value of the object from the previous positioning location point to the current positioning location point may be determined based on the coordinate of the current positioning location point, the coordinate of the previous positioning location point of the current positioning location point, and the acquisition time interval between the current positioning location point and the previous positioning location point. In response to determining that the average speed value is smaller than or equal to a preset speed threshold, a variance of the precision factors of a plurality of positioning location points including the current positioning location point may be obtained based on the precision factors of the plurality of positioning location points. In response to determining that the variance of the precision factors is smaller than a preset precision factor threshold, the current positioning location point may be retained. In response to determining that the variance of the precision factors is not smaller than the preset precision factor threshold, the current positioning location point may be deleted. In this way, the accuracy of the obtained current positioning location point may be improved, and the accuracy of subsequently determining whether the object is off-route can be ensured. The preset speed threshold may be determined in advance according to traveling speeds of a large count of service provider terminals.

In 1720, the processing device 400 may determine a second distance between each of the one or more positioning location points and the first navigation route.

In some embodiments, the second distance may be defined similarly to the first distance may be similar. In some embodiments, the first distance and the second distance may be the same, for example, may both be vertical distances from each of the one or more positioning location points to the first navigation route. The first distance and the second distance may also be different. For example, the first distance may be the vertical distance from each of the one or more positioning location points to the first navigation route, and the second distance may be a distance from each of the one or more positioning location points to the first navigation route along a certain direction (e.g., a direction perpendicular to the traveling direction).

In some embodiments, the vertical distance of each positioning location point to the first navigation route may be determined based on the coordinates of one or more positioning location points, and the vertical distances may be determined as the second distances.

In 1730, the processing device 400 may determine whether the current positioning location point deviates from the first navigation route based on the second distances.

In some embodiments, whether the current positioning location point deviates from the first navigation route may be determined based on the second distance from the current positioning location point to the first navigation route. In some embodiments, if the second distance from the current positioning location point to the first navigation route is smaller than or equal to a preset second distance threshold, it is considered that the current positioning location point does not deviate from the first navigation route. If the second distance from the current positioning location point to the first navigation route is greater than the preset second distance threshold, it is considered that the current positioning location point deviates from the first navigation route.

In other embodiments, a distance variance of the one or more second distances may be determined based on the second distance between the each of the one or more positioning location points and the first navigation route. Whether the distance variance exceeds a preset variance threshold may be determined. In response to determining that the distance variance exceeds the preset variance threshold, that the current positioning location point deviates from the first navigation route may be determined.

In some embodiments, in response to determining that the current positioning location point deviates from the first navigation route, the processing device 400 may determine deviated positioning location points that deviate from the first navigation route from the one or more positioning location points. The deviated positioning location points may be positioning location points that are not located on the first navigation route among the one or more positioning location points.

In 1740, in response to determining that the current positioning location point deviates from the first navigation route, the processing device 400 may update a count of deviated positioning location points based on the current positioning location point. Specifically, operation 1740 may be performed by the count updating module 491.

In some embodiments, the count of deviating location points may be stored in a database, and if the current positioning location point deviates from the first navigation route, the count of deviating location points in the database may be added by one. In this way, the count of deviated positioning location points may be updated in time, so that whether the object is off-route can be identified more accurately and timely.

In some embodiments, if the current positioning location point does not deviate from the first navigation route, the count of deviation positioning location points may be reset to zero in the database.

In 1750, in response to determining that the current positioning location point deviates from the first navigation route, the processing device 400 may determine deviated positioning location points that deviate from the first navigation route from the one or more positioning location points.

The method for determining whether other positioning location points (that is, the positioning location points obtained before the current positioning location point is obtained) in the one or more positioning location points except the current positioning location point deviate from the first navigation route (that is, whether they are deviated positioning location points) may be similar to the method for determining whether the current positioning location point deviates from the first navigation route. In some embodiments, the determining of the deviated positioning location points may include determining the count of the deviated positioning location points.

In 1760, the processing device 400 may determine whether the object is off-route based on information of the deviated positioning location points.

In some embodiments, it may be determined whether the object is off-route based on the count of the deviated positioning location points and a preset count threshold. For example, if the count of deviated positioning location points is smaller than the preset count threshold, it is determined that the object is not off-route; if the count of deviating positioning location points is greater than or equal to the preset count threshold, it is determined that the object is off-route.

It should be noted that, in the above operations, the operation of determining whether the current positioning location point is deleted in operation 1710 may not be performed, and subsequent operations may be directly performed in operation 1720 based on the obtained current positioning location point. In addition, the operation 1740 may be performed before operation 1750 is performed, or may be performed after operation 1760 is performed.

In some embodiments, after that the object is off-route is determined, the first navigation route may be updated based on the information of the deviated positioning location points and the information of the current positioning location point. Specifically, the operation of updating the first navigation route may be performed by a route updating module.

In some embodiments, a color different from a color of the first navigation route before first navigation route is updated may be used for updating the first navigation route on the service request terminal. For example, if the first navigation route is displayed in blue on the service request terminal before the first navigation route is updated, and the first navigation route may be displayed in yellow after the first navigation route is updated.

FIG. 18 is a flowchart illustrating an exemplary off-route identification process according to some embodiments of the present disclosure. The following take an object as a service provider terminal as an example.

The terms “service request” and “order” are used interchangeably to refer to a request initiated by a passenger, a service requester entity, a driver, a service provider entity, or a supplier, or the like, or any combination thereof. The “service request” or “order” may be received by a passenger, a service requester entity, a driver, a service provider, or a supplier, or the like, or any combination thereof. Service requests can be paid or free.

Currently, when a service provider terminal serves a current order, it can send its own positioning location point information to a backend server. The backend server can generate traveling trajectory information of the service provider terminal based on the positioning location point information, and send the traveling trajectory information to the service request terminal. If the positioning location point information sent by the service provider terminal to the backend server is inaccurate due to the precision factor of positioning components of the service provider terminal or environmental factors, traveling trajectory information of the service provider terminal generated by the backend server based on the inaccurate positioning location point information may be also inaccurate, which may lead to inaccurate determination of whether the service provider terminal deviates from the navigation route (e.g., the first navigation route) based on the traveling trajectory information. In view of this, some embodiments of the present disclosure provide a yaw identification method, which will be described in detail in conjunction with the following specific embodiments.

The off-route identification process may include the following specific operations 1801-1803.

In 1801, the positioning location point information of the service provider terminal reported by the service provider terminal according to a set time interval may be received when a current order is served.

In some embodiments, the service provider terminal may be a tablet computer, a laptop computer, or a built-in device in a motor vehicle such as a vehicle terminal, associated with the service provider entity, where the service provider entity is a driver in the field of travel.

When the service request terminal (the passenger terminal) initiates an order request, after the backend server may assign the corresponding service provider terminal to the service request terminal based on the service request, a navigation route corresponding to the current order may be determined based on departure point information of the service request terminal in the service request and the current position information of the service provider terminal. Then the service provider terminal may be prompted to pick up the passenger according to the navigation route.

The service provider terminal may report the positioning location point information of the service provider terminal to the backend server at a set time interval, such as every 1 s, during the pick-up process, and then the backend server may determine the traveling trajectory of the service provider terminal based on the positioning location position information, and then determine whether the driver deviates from the navigation route.

In some embodiments, considering that the positioning location point information reported by the service provider terminal may be obviously inaccurate, it is necessary to detect received each piece of positioning location point information. Specifically, in operation 1801, the receiving the positioning location point information of the service provider terminal reported by the service provider terminal according to the set time interval when a current order is served may include the following operations.

(1) For received each piece of positioning location point information, a precision factor, a direction angle and a speed value of the positioning location point in the positioning location point information may be extracted.

(2) In response to determining that the precision factor of the positioning location point is not greater than a preset precision factor threshold, the direction angle of the positioning location point is not smaller than 0, and the speed value of the positioning location point is not smaller than 0, the information of the positioning location point may be retained. In response to determining that the precision factor of the positioning location point is greater than the preset precision factor threshold, the directional angle of the positioning location point is smaller than 0, or the speed value of the positioning location point is smaller than 0, the information of the positioning location point may be deleted.

In some embodiments, the precision factor of a positioning location point may refer to a horizontal precision factor of the coordinate of the positioning location point. In some embodiments, the smaller the precision factor is, the closer the coordinate of the service provider terminal in the positioning location point information reported by the service provider terminal may be to a real location. For example, if the precision factor is equal to 1000 dm, it indicates that an error range of the coordinate is 1000 dm. In some embodiments, the precision factor threshold may be equivalent to a maximum error range. When the precision factor of a positioning location point is greater than the maximum error range, it is considered that the coordinate of the positioning location point is relatively different from the real location of the service provider terminal, and the positioning location point information may be deleted.

The direction angle of the positioning location point here refers to a direction angle between a traveling direction of the service provider terminal and the due north direction of a geodetic coordinate system. The direction angle may be also be characterized by a speed direction. Under normal circumstances, the direction angle is greater than or equal to 0, and if the direction angle of the positioning location point is smaller than 0, it means that the positioning location point information provided by the service provider terminal is wrong data, and the positioning location point information may also be deleted.

The speed value of a positioning location point here refers to an instantaneous speed value of the service provider terminal during traveling. The instantaneous speed value is greater than or equal to 0 under normal circumstances. If the instantaneous speed value is smaller than 0, it means that the positioning location point information provided by the service provider terminal is wrong data, and the positioning location point information may also be deleted.

In 1802, whether there is a mapping location point of a current positioning location point of the service provider terminal on the navigation route (e.g., the first navigation route) corresponding to the current order may be determined. The navigation routes in the following may all be understood as the first navigation routes, which will not be described in detail below.

Due to the low accuracy of the positioning components of the service provider terminal, the positioning location point may drift, that is, even if the service provider terminal is located on the navigation route, the coordinates of the positioning location points reported by the service provider terminal may not be on the navigation route. In this case, whether there is a mapping location point of the current positioning location point of the service provider terminal on the navigation route needs to be determined by some means.

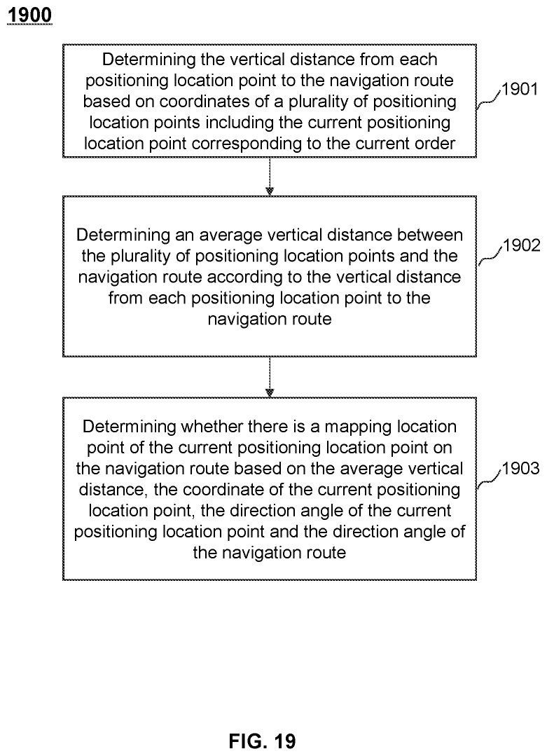

Specifically, each piece of positioning location point information here may include the coordinate and the direction angle of the positioning location point. FIG. 19 is a flowchart illustrating an exemplary process for determining whether there is a mapping location point according to some embodiments of the present disclosure. As described in FIG. 19, whether there is a mapping location point of the current positioning location point of the service provider terminal on the navigation route corresponding to the current order may be determined in the following manner. The process 1900 may include operations 1901-1902.

In 1901, the vertical distance from each positioning location point to the navigation route may be determined based on coordinates of a plurality of positioning location points including the current positioning location point corresponding to the current order.

Specifically, the coordinates of the plurality of positioning location points and the navigation route may be converted into an image coordinate system, and then the vertical distance from each positioning location point to the navigation route may be determined in the image coordinate system.

In 1902, an average vertical distance between the plurality of positioning location points and the navigation route may be determined according to the vertical distance from each positioning location point to the navigation route.

Here, the average vertical distance may be calculated according to the following Equation (1):

$$M = \frac{{\sum }_{i = 1}^{n} {d}_{i}}{n} ; \qquad ( 1 )$$

Where, M denotes the average vertical distance, n denotes a count of the plurality of positioning location points, and dᵢ Denotes the vertical distance between the ith positioning location point and the navigation route.

In 1903, whether there is a mapping location point of the current positioning location point on the navigation route may be determined based on the average vertical distance, the coordinate of the current positioning location point, the direction angle of the current positioning location point and the direction angle of the navigation route.

Here, the direction angle of the current positioning location point may be included in the positioning location point information reported by the service provider terminal. The direction angle may refer to an angle between the traveling direction of the service provider terminal and the due north direction in the geodetic coordinate system, and the direction angle of the navigation route may refer to the angle between the navigation route and the due north direction in the geodetic coordinate system.

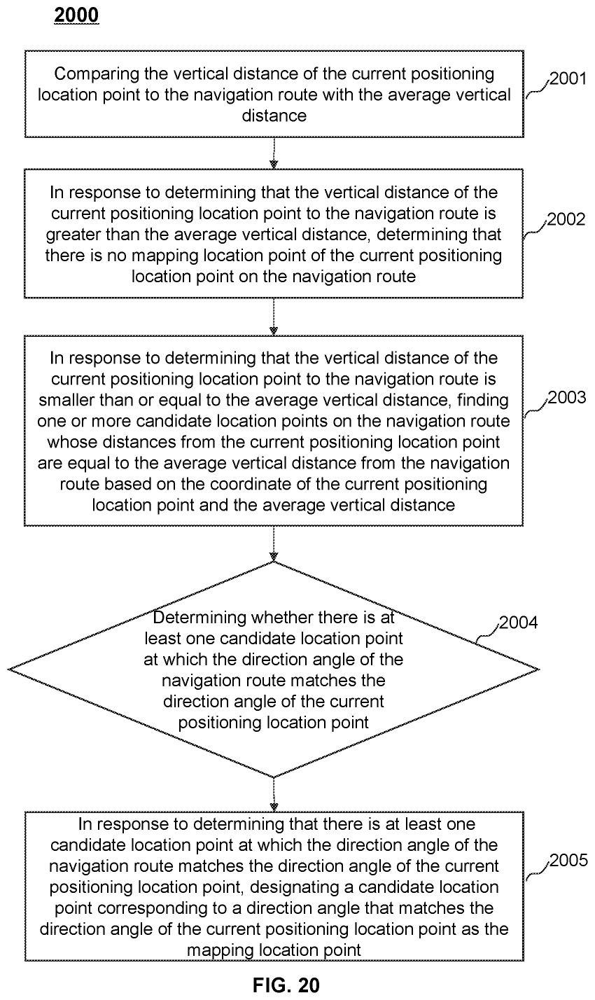

Specifically, in operation 1903, whether there is a mapping location point of the current positioning location point on the navigation route may be determined based on the average vertical distance, the coordinate of the current positioning location point, the direction angle of the current positioning location point and the direction angle of the navigation route. FIG. 20 is a flowchart illustrating an exemplary process for determining whether there is a mapping location point according to some embodiments of the present disclosure. As described in FIG. 20, the operation 1903 may include the following operations 2001-2005.

In 2001, the vertical distance of the current positioning location point to the navigation route may be compared with the average vertical distance.

In 2002, in response to determining that the vertical distance of the current positioning location point to the navigation route is greater than the average vertical distance, it is determined that there is no mapping location point of the current positioning location point on the navigation route.

Here, the vertical distance from the current positioning location point to the navigation route may be a vertical distance from the current positioning location point to an edge of the navigation route. If the navigation route is a curved route, the vertical distance from the current positioning location point to the navigation route may be a vertical distance from the current positioning location point to a tangent of the edge of the navigation route. If the vertical distance is greater than the average vertical distance, it is determined that there is no mapping location point of the current positioning location point on the navigation route, that is, the current positioning location point cannot be bound to the navigation route.

In 2003, in response to determining that the vertical distance of the current positioning location point to the navigation route is smaller than or equal to the average vertical distance, one or more candidate location points (e.g., the candidate mapping location points) on the navigation route whose distances from the current positioning location point are equal to the average vertical distance may be found from the navigation route based on the coordinate of the current positioning location point and the average vertical distance.

In response to determining that the vertical distance of the current positioning location point to the navigation route is smaller than or equal to the average vertical distance, one or more candidate location points on the navigation route whose distances from the current positioning location point are equal to the average vertical distance may be determined. Specifically, both the navigation route and the current positioning location point are placed in the image coordinate system. Since the navigation route can be regarded as composed of multiple location points, candidate location points on the navigation route whose distances from the current positioning location point are equal to the average vertical distance may be found in the image coordinate system.

In some embodiments, in order to more accurately determine whether the candidate location points are the mapping location point of the current positioning location point, other factors need to be further considered, for example, the direction angle may be considered.

In 2004, whether there is at least one candidate location point at which the direction angle of the navigation route matches the direction angle of the current positioning location point may be determined.

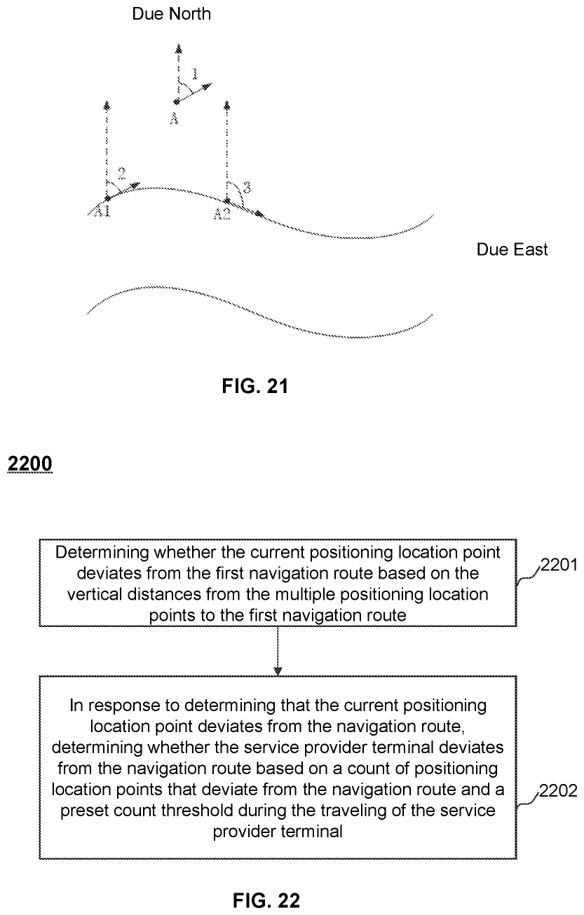

For example, FIG. 21 illustrates an exemplary schematic diagram for selecting a mapping location point on the first navigation route according to some embodiments of the present disclosure. As shown in FIG. 21, for a current positioning location point A, two candidate location points A1 and A2 of the current positioning location point A may be found on a navigation route. An angle between the direction of the current positioning point A and the due north direction is angle 1, and the direction angle of the navigation route at the candidate location point A1 refers to an angle between a tangent of the navigation route at the candidate location point A1 and the due north direction, where the tangent direction of the navigation route corresponds to the traveling direction of the service provider terminal. For example, in FIG. 21, if it is determined that the traveling direction of the service provider terminal is east according to a trajectory orientation of the service provider terminal, the direction angle corresponding to the candidate location point A1 is angle 2, and the direction angle corresponding to the candidate location point A2 is angle 3. Through further comparison, it can be determined that the angle 2 is closer to the angle 1, and it can be determined that there is the candidate location point A1 at which the direction angle of the navigation route matches the direction angle of the current positioning location point A.

In 2005, in response to determining that there is at least one candidate location point at which the direction angle of the navigation route matches the direction angle of the current positioning location point, a candidate location point corresponding to a direction angle that matches the direction angle of the current positioning location point may be designated as the mapping location point.

Taking the above embodiment as an example, it can be determined that the mapping location point of the current positioning location point A is A1.

Further, the off-route identification process provided by the embodiments of the present disclosure may further include the following operations.

(1) After that there is a mapping location point on the navigation route is determined, the coordinate of the current positioning location point in the traveling trajectory information of the service provider terminal may be replaced with the coordinate of the mapping location point.

(2) the updated traveling trajectory information of the service provider terminal may be sent to the service request terminal.

In some embodiments, after it is determined that there is a mapping location point on the navigation route, for example, after it is determined that there is a mapping location point A1 of the current positioning location point A on the navigation route, the coordinate of the current positioning location point may be replaced with the coordinate of the mapping location point, so that after the current positioning location point drifts out of the navigation route, the current positioning location point may be replaced with the mapping location point on the navigation route. In this way, the traveling trajectory of the driver terminal displayed on the passenger terminal may be still in the navigation route, so as to avoid that the inaccurate traveling trajectory information of the service provider terminal generated based on drifted positioning point information reported by the service provider terminal causes the passenger to cancel the order and waste resources.

In addition, before the coordinate of the current positioning location point in the traveling trajectory information of the service provider terminal is replaced with the coordinate of the mapping location point, it is also possible to consider whether the current positioning location point is a bad point, for example, the distance between the current positioning location point and the previous positioning location point of the current positioning location point exceeds the preset distance threshold. For example, according to the normal travelling speed of the vehicle, when the time interval is 1 second, the distance between two adjacent location points has a maximum preset distance threshold. Whether a distance between the current positioning location point and the previous undeleted positioning location point of the current positioning location point exceeds the maximum preset distance threshold may be determined. If the distance between the current positioning location point and the previous undeleted positioning location point of the current positioning location point exceeds the maximum preset distance threshold, it indicates that the current positioning location point itself may be a bad point. The traveling trajectory information of the service provider terminal is not updated based on the mapping location point of the current positioning location point.

In addition, whether the current positioning location point is a bad point may be determined by calculating an average speed value between the current positioning location point and the previous positioning location point, and determining whether the average speed value is greater than a preset speed threshold value. For example, an acquisition time interval between two adjacent positioning location points is 1 s. When the service provider terminal drives at the normal speed, a speed threshold may be set for the average speed from the previous positioning location point to the current positioning location point. When it is determined that the average speed value between the current positioning location point and the previous positioning location point is greater than the speed threshold, it means that the current positioning location point itself may be a bad point. The traveling trajectory information of the service provider terminal is not updated based on the mapping location point of the current positioning location point.

The above method for determining whether there is a mapping location point of the current positioning location point of the service provider terminal on the navigation route corresponding to the current order is only one specific embodiment, and other embodiments may also be used to determine whether there is a mapping location point. For example, whether there is a mapping location point of the current positioning location point may be determined according to a minimum distance between the current positioning location point and the trajectory points corresponding to the navigation route. Since the navigation route may be regarded as composed of a large count of trajectory points, whether there is a mapping location point of the current positioning location point may be determined according to whether the minimum distance between the current positioning location point and the trajectory points is smaller than a preset distance threshold, which will not be repeated here.

In 1803, in response to determining that there is no mapping location point on the navigation route, whether the service provider terminal deviates from the navigation route may be determined based on the vertical distances from multiple positioning location points including the current positioning location point corresponding to the current order to the navigation route.

In some embodiments, in response to determining that there is no mapping location point on the navigation route, that is, when the current positioning location point cannot be successfully bound, considering that the vertical distance between the current positioning location point and the navigation route is relatively far, it indicates that the service provider terminal may be off-route. In order to further determine whether the service provider terminal has off-route, whether the service provider terminal deviates from the navigation route may be determined based on the vertical distances from multiple positioning location points including the current positioning location point corresponding to the current order to the navigation route.

Specifically, FIG. 22 is a flowchart illustrating an exemplary process for determining whether an object is off-route according to some embodiments of the present disclosure. As described in FIG. 22, one or more operations of the process 2200 may be performed to achieve at least part of operation 1803. The process 2200 may include the following operations 2201-2202.

In 2201, whether the current positioning location point deviates from the first navigation route may be determined based on the vertical distances from the multiple positioning location points to the first navigation route.

In 2202, in response to determining that the current positioning location point deviates from the navigation route, whether the service provider terminal deviates from the navigation route may be determined based on a count of positioning location points that deviate from the navigation route and a preset count threshold during the traveling of the service provider terminal.

Here, the determining of whether the service provider terminal deviates from the navigation route may include two operations. In the first operation, whether the current positioning location point deviates from the navigation route may be determined based on the vertical distances between the multiple positioning location points and the navigation route. The multiple positioning location points may include the current positioning location point. In the second operation, after that the current positioning location point deviates from the navigation route is determined, whether the service provider terminal deviates from the navigation route may be determined according to the count of positioning location points that deviate from the navigation route during the traveling of the service provider terminal and the preset count threshold.

In some embodiments, each piece of location point information reported by the service provider terminal may include the precision factor and coordinate of the positioning location point. In some embodiments, if that there is no mapping location point on the navigation route is determined in operation 1803, before the operation 2201 is performed, the off-route identification process provided by the present disclosure may also include the following operations.

(1) an average speed value of the service provider terminal from the previous positioning location point to the current positioning location point may be determined based on the coordinate of the current positioning location point, a coordinate of a previous positioning location point of the current positioning location point, and an acquisition time interval between the current positioning location point and the previous positioning location point.

Here, the previous positioning location point may be a previous positioning location point adjacent to the current positioning location point reserved by the server. For example, the service provider terminal may report one piece of positioning location point information every 1s. If the backend server has received the 10th piece of positioning location point information by the current moment, and the 10th piece of positioning location point information has not been deleted, the current positioning location point may be the 10th positioning location point, and the previous positioning location point of the current positioning location point may be one positioning location point that is adjacent to the 10th positioning location point and has not been deleted.

Here, if the current positioning location point is the 10th positioning location point and the previous positioning location point is the 9th positioning location point, the acquisition time interval between the current positioning location point and the previous positioning location point is 1s; if the current positioning location point is the 10th positioning location point and the previous positioning location point is the 8th positioning location point, the acquisition time interval between the current positioning location point and the previous positioning location point is 2s. In this way, after a distance difference between the previous positioning location point and the current positioning location point is determined according to the coordinates, the average speed value of the service provider terminal from the previous positioning location point to the current positioning location point may be determined.

(2) in response to determining that the average speed value is smaller than or equal to the preset speed threshold, a variance of the precision factors of the multiple positioning location points may be obtained based on the precision factors of the multiple positioning location points.

The preset speed threshold here may be determined in advance according to travelling speeds of a large count of service provider terminals. If the average speed value is greater than the preset speed threshold, it can be determined that the current positioning location point is a bad point, and the current positioning location point may be directly deleted and continue to wait to receive the next positioning location point.

After that the average speed value is smaller than or equal to the preset speed threshold is determined, it is also possible to continue to determine a variance the precision factors of the multiple positioning location points based on the precision factors of the multiple positioning location points including the current positioning location point according to the following Equation (2).

$${V}_{p} = \frac{{\sum }_{i = 1}^{n} {( {P}_{i} - \overline{p} )}^{2}}{n} , \qquad ( 2 )$$

Where, Vₚ Denotes the variance of the precision factors; n denotes a count of positioning location points; Pᵢ Denotes the precision factor of the ith positioning location point; P̅ Denotes the average value of the precision factors of the n positioning location points.

(3) in response to determining that the variance of the precision factors is smaller than a precision factor threshold, the current positioning location point may be retained.

In response to determining that the variance of the precision factor is smaller than the precision factor threshold, it means that a fluctuation range of the precision factors of the multiple positioning location points including the current positioning location point is small, then it can be determined that the precision factor of the current positioning location point is relatively close to the precision factors of the multiple positioning location points. That is, the precision factor of the current positioning location point is relatively stable and the current positioning location point is not a bad point, and it can continue to determine whether the current positioning location point deviates from the navigation route.

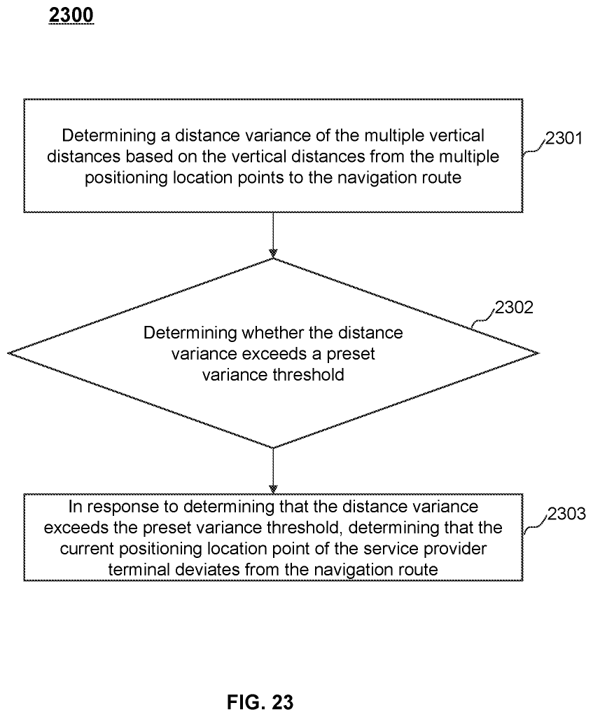

Specifically, FIG. 23 is a flowchart illustrating an exemplary process for determining whether a current positioning location point deviates from a navigation route according to some embodiments of the present disclosure. As described in FIG. 23, one or more operations of the process 2300 may be performed to achieve at least part of operation 2201. The process 2300 may include the following operations 2301-2303.

In 2301, a distance variance of the multiple vertical distances may be determined based on the vertical distances from the multiple positioning location points to the navigation route.

Specifically, an average vertical distance of the multiple positioning location points may be calculated based on the vertical distances from the multiple positioning location points to the first navigation route. Then the distance variance of the multiple vertical distances may be determined based on the vertical distance from each of the multiple positioning location points to the navigation route and the average vertical distance according to the following Equation (3)

$${V}_{d} = \frac{{\sum }_{i = 1}^{n} {( {d}_{i} - M )}^{2}}{n} , \qquad ( 3 )$$

Where, V_{d} Denotes the distance variance, n denotes a count of positioning location points, dᵢ Denotes the vertical distance from the ith positioning location point to the navigation route, M denotes the average vertical distance.

In 2302, whether the distance variance exceeds a preset variance threshold may be determined.

The preset variance threshold may be a value set in advance, indicating a maximum fluctuation range of the vertical distances from the multiple positioning location points including the current positioning location point to the navigation route that are allowed.

In 2303, in response to determining that the distance variance exceeds the preset variance threshold, that the current positioning location point of the service provider terminal deviates from the navigation route may be determined.

In some embodiments, in response to determining that the distance variance exceeds the preset variance threshold, that the current positioning location point of the service provider terminal deviates from the navigation route may be determined.

In response to determining that the distance variance exceeds the preset variance threshold, that the current positioning location point of the service provider terminal does not deviate from the navigation route may be determined. In this case, the current positioning location point may be ignored, and the determination of the next positioning location point may be continued, that is, the next positioning location point may be used as the current positioning location point, and operation 1802 and subsequent off-route identification may be performed, which will not be repeated here.

In some embodiments, the off-route identification process may further include the following operations.

A pre-stored off-route point quantity database may be updated. For example, the off-route point quantity database may be cleared when the current positioning location point does not deviate from the navigation route.

The off-route point database may be used to store a count of positioning location points that deviate from the navigation route. If it is determined that the current positioning location point deviates from the navigation route, the count of positioning location points that deviate from the navigation route in the off-route point quantity database may be increased by 1; if it is determined that the current positioning location point does not deviate from the navigation route, the off-route point quantity database may be cleared.

In some embodiments, if it is determined that there is a mapping location point of the current positioning location point on the navigation route, and the coordinate of the current positioning location point are replaced by the coordinate of the mapping location point, the off-route point quantity database may also be cleared.

Specifically, in operation 2202, the determining of whether the service provider terminal deviates from the navigation route based on a count of positioning location points that deviate from the navigation route and a preset count threshold during the traveling of the service provider terminal may include following operations.

(1) whether the count of positioning location points that deviate from the navigation route in the updated off-route point quantity database is greater than or equal to the preset count threshold may be determined.

The preset count threshold may be related to the variance of the precision factors of multiple positioning location points including the current positioning location point. If the variance of the precision factors is small, the preset count threshold may be small, and if the variance of the precision factors is large but does not exceed the precision factor threshold mentioned above, the preset count threshold may be large. For example, the precision factors may be divided into multiple intervals. The first interval is greater than or equal to 0 and smaller than 10, the second interval is greater than or equal to 10 and smaller than 20, and the third interval is greater than or equal to the precision factor threshold 20. If the variance of the precision factors here belongs to the first interval, the preset count threshold is L, and if the variance of the precision factors here belongs to the second interval, the preset count threshold is H, and H may be greater than L.

Because the current positioning location point keeps changing with the increase of the received positioning location points, the variance of the precision factors corresponding to the multiple positioning location points will also change, so the preset count threshold may be changed.

(2) in response to determining that the count of positioning location points that deviate from the navigation route in the updated off-route point quantity database is greater than or equal to the preset count threshold, that the service provider terminal deviates from the navigation route may be determined.

If the current preset count threshold is H, and it is determined that the current positioning location point deviates from the navigation route, and the count of positioning location points that deviate from the navigation route in the updated off-route point quantity database is greater than or equal to the H, it may be determined that the service provider terminal deviates from the navigation route.

In addition, after it is determined that the service provider terminal deviates from the navigation route, if there are multiple routes from the current geographic location of the service provider terminal to the departure point of the service request terminal, the off-route identification process provided by the embodiments of the present disclosure may also update the navigation route.

Specifically, the navigation route may be updated according to the follow operations.

(1) coordinates of a plurality of positioning location points that deviate from the navigation route may be extracted.

(2) a target navigation route matching the coordinates of the plurality of positioning location points that deviate from the navigation route may be determined based on the coordinates of the plurality of positioning location points that deviate from the navigation route, a coordinate of a current location of the service provider terminal, and a coordinate of the destination of the service provider terminal.

The coordinate of the current location of the service provider terminal may be the coordinate of the current positioning location point, and the coordinate of the destination of the service provider terminal may be the coordinate of the departure location of the service request terminal. In some embodiments, it may be re-determined whether there is a new navigation route based on rough navigation data, with the coordinate of the current location of the service provider terminal as the starting point and the coordinate of the destination of the service provider terminal as the ending point. If there are multiple new navigation routes, the navigation route that coincides with the coordinates of the positioning location points that deviate from the navigation route may be determined as the target navigation route.

(3) the navigation route may be updated based on the target navigation route.

The coordinates of the plurality of positioning location points that deviate from the navigation route may be extracted. For example, the coordinates of three positioning location points A, B, and C that consecutively deviate from the navigation route may be determined. It is re-determined that there are three new navigation routes with the coordinate of the current location of the service provider terminal as the starting point and the coordinate of the destination of the service provider terminal as the ending point. Further, if that the positioning location points A, B, and C coincide with the second navigation route is determined, the second navigation route may be determined as the target navigation route, and information of the target navigation route may be sent to the service request terminal.

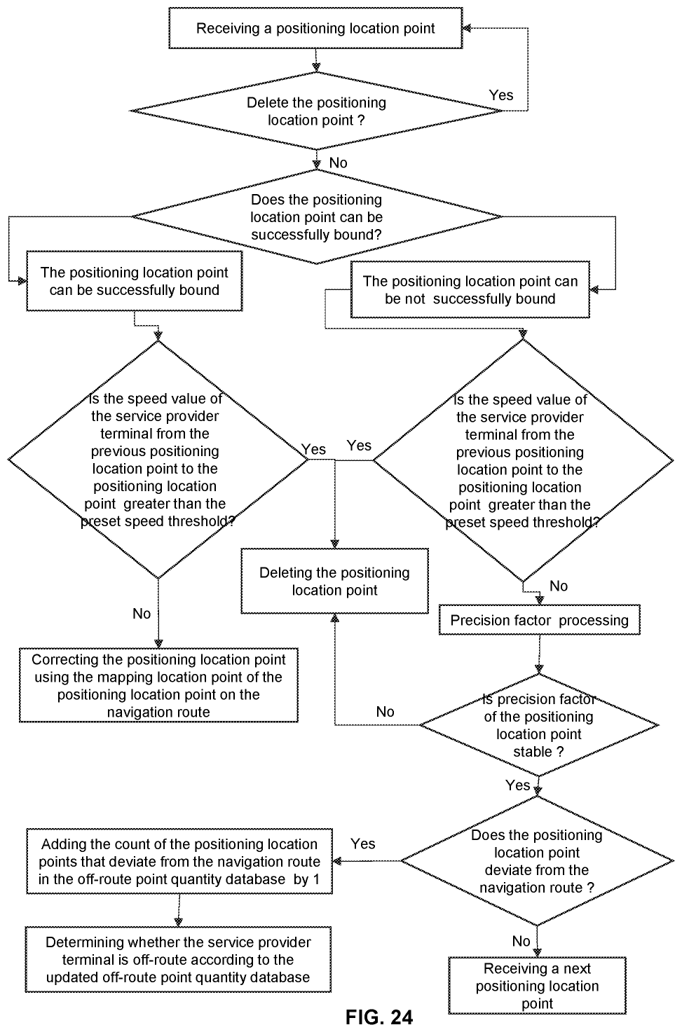

FIG. 24 is a flowchart illustrating an exemplary off-route identification process according to some embodiments of the present disclosure. The off-route identification process is illustrated by a specific embodiment in FIG. 24.

After a positioning location point is received, whether to delete the positioning location point may be determined first according to an instantaneous speed value, a direction angle and a precision factor of the positioning location point. If the instantaneous speed value is not smaller than 0, the direction angle is not smaller than 0, and the precision factor is not greater than the precision factor threshold, the positioning location point may not be deleted. If the instantaneous speed value is smaller than 0, the direction angle is smaller than 0, or the precision factor is greater than the precision factor threshold, the positioning location point may be deleted, and continue to determine the next received positioning location point.

If it is determined not to delete the positioning location point, whether the positioning location point can be successfully bound may be determined, that is, whether the mapping location point of the positioning location point can be found on the navigation route, according to the process mentioned above, and the descriptions of which are not repeated here. If the positioning location point can be successfully bound and the speed value of the service provider terminal from the previous positioning location point to the positioning location point is not greater than the preset speed threshold, the positioning location point may be corrected using the mapping location point of the positioning location point on the navigation route.

If the positioning location point can be not successfully bound, and it is determined that the speed value of the service provider terminal from the previous positioning location point to the positioning location point is not greater than the preset speed threshold, and the precision factor of the positioning location point is determined to be stable through multiple positioning location points, continue to determine whether the positioning location point deviates from the navigation route. If it is determined that the positioning location point deviates from the navigation route, the count of the positioning location points that deviate from the navigation route in the off-route point quantity database may be added 1, and whether the service provider terminal is off-route may be determined according to the updated the off-route point quantity database.

To sum up, the off-route identification process provided by the embodiments of the present disclosure may determine whether the current positioning location point is successfully bound (mapped to the navigation route) after the current positioning location point is received. If the current positioning location point is not successfully bound, it is indicated that there is a possibility of off-route at present, and then whether the object is the off-route may be determined based on the vertical distances from the nearest multiple positioning location points to the navigation route. In this way, the off-route identification may be achieved without accurate road network data. In addition, the off-route identification may be comprehensively determined through the two aspects of whether the current positioning location point is successfully bound and the vertical distances from the multiple positioning location points to the navigation route, which improves the accuracy of the off-route identification.

In some embodiments, if it is determined that there is a mapping location point of the current positioning location point, the current positioning location point may be replaced with the mapping location point on the navigation route, which is equivalent to performing error correction on the traveling route of the driver terminal, and avoids that the traveling trajectory of the driver terminal displayed on the passenger terminal deviates from the navigation route due to the drifts of the positioning location points uploaded by the positioning components of the service provider terminal or environmental factors, thereby reducing that the passenger cancels the order due to the deviation of the driver from the navigation route, and improving the efficiency of resource allocation.

FIG. 26 is a schematic diagram illustrating an exemplary electronic device according to some embodiments of the present disclosure. This embodiment of the present disclosure further provides an electronic device 2600. As shown in FIG. 26, may include a processor 2601, a storage medium 2602, and a bus 2603. The storage medium 2602 may store machine-readable instructions executable by the processor 2601 (e.g., the execution instructions corresponding to the receiving module 413, the judgement module 420, the determining module 430 in the system in FIG. 25, etc.). When the electronic device 2600 is operating, the processor 2601 communicates with the storage medium 2602 may be via the bus 2603. When the machine-readable instructions are executed by the processor 2601, the following operations may be performed. Positioning location point information of a service provider terminal reported by the service provider terminal according to a set time interval may be received when a current order is served. Whether there is a mapping location point of a current positioning location point of the service provider terminal on a navigation route corresponding to the current order may be determined. In response to determining that there is no mapping location point on the navigation route, whether the service provider terminal deviates from the navigation route may be determined based on vertical distances from multiple positioning location points including the current positioning location point corresponding to the current order to the navigation route.

In some embodiments, each piece of positioning location point information may include a coordinate and a direction angle of the positioning location point. The instructions executed by the processor 2601 may include: determining the vertical distance from each positioning location point to the navigation route based on coordinates of a plurality of positioning location points including the current positioning location point corresponding to the current order; determining an average vertical distance between the plurality of positioning location points and the navigation route according to the vertical distance from each positioning location point to the navigation route; determining whether there is a mapping location point of the current positioning location point on the navigation route based on the average vertical distance, the coordinate of the current positioning location point, the direction angle of the current positioning location point and the direction angle of the navigation route.

In some embodiments, the instructions executed by the processor 2601 may include: comparing the vertical distance of the current positioning location point to the navigation route with the average vertical distance; in response to determining that the vertical distance of the current positioning location point to the navigation route is greater than the average vertical distance, determining that there is no mapping location point of the current positioning location point on the navigation route; in response to determining that the vertical distance of the current positioning location point to the navigation route is smaller than or equal to the average vertical distance, finding one or more candidate location points on the navigation route whose distances from the current positioning location point are equal to the average vertical distance from the navigation route based on the coordinate of the current positioning location point and the average vertical distance; determining whether there is at least one candidate location point at which the direction angle of the navigation route matches the direction angle of the current positioning location point; in response to determining that there is at least one candidate location point at which the direction angle of the navigation route matches the direction angle of the current positioning location point, determining a candidate location point corresponding to a direction angle that matches the direction angle of the current positioning location point as the mapping location point.

In some embodiments, the instructions executed by the processor 2601 may include: replacing the coordinate of the current positioning location point in the traveling trajectory information of the service provider terminal with the coordinate of the mapping location point after that there is a mapping location point on the navigation route is determined; sending the updated traveling trajectory information of the service provider terminal to the service request terminal.

In some embodiments, the instructions executed by the processor 2601 may include: for received each piece of positioning location point information, extracting a precision factor, a direction angle and a speed value of the positioning location point in the positioning location point information; in response to determining that the precision factor of the positioning location point is not greater than a preset precision factor threshold, the direction angle of the positioning location point is not smaller than 0, and the speed value of the positioning location point is not smaller than 0, retaining the information of the positioning location point; in response to determining that the precision factor of the positioning location point is greater than the preset precision factor threshold, the directional angle of the positioning location point is smaller than 0, or the speed value of the positioning location point is smaller than 0, deleting the information of the positioning location point.

In some embodiments, the instructions executed by the processor 2601 may include: determining whether the current positioning location point deviates from the first navigation route based on the vertical distances from the multiple positioning location points to the first navigation route; in response to determining that the current positioning location point deviates from the navigation route, determining whether the service provider terminal deviates from the navigation route based on a count of positioning location points that deviate from the navigation route and a preset count threshold during the traveling of the service provider terminal.

In some embodiments, each piece of location point information reported by the service provider terminal may include the precision factor and coordinate of the positioning location point. in response to determining that there is no mapping location point on the navigation route, before whether the current positioning location point deviates from the first navigation route is determined based on the vertical distances from the multiple positioning location points to the first navigation route, the instructions executed by the processor 2601 may include: determining an average speed value of the service provider terminal from the previous positioning location point to the current positioning location point may be determined based on the coordinate of the current positioning location point, a coordinate of a previous positioning location point of the current positioning location point, and an acquisition time interval between the current positioning location point and the previous positioning location point; in response to determining that the average speed value is smaller than or equal to the preset speed threshold, obtaining a variance of the precision factors of the multiple positioning location points based on the precision factors of the multiple positioning location points; in response to determining that the variance of the precision factors is smaller than a precision factor threshold, retaining the current positioning location point.

In some embodiments, the instructions executed by the processor 2601 may include: determining a distance variance of the multiple vertical distances based on the vertical distances from the multiple positioning location points to the navigation route; determining whether the distance variance exceeds a preset variance threshold; in response to determining that the distance variance exceeds the preset variance threshold, determining that the current positioning location point of the service provider terminal deviates from the navigation route.

In some embodiments, after that the current positioning location point of the service provider terminal deviates from the navigation route is determined, the instructions executed by the processor 2601 may include: updating a pre-stored off-route point quantity database, for example, clearing the off-route point quantity database when the current positioning location point does not deviate from the navigation route. In some embodiments, the instructions executed by the processor 2601 may include: determining whether the count of positioning location points that deviate from the navigation route in the updated off-route point quantity database is greater than or equal to the preset count threshold; in response to determining that the count of positioning location points that deviate from the navigation route in the updated off-route point quantity database is greater than or equal to the preset count threshold, determining that the service provider terminal deviates from the navigation route.

In some embodiments, the instructions executed by the processor 2601 may include: after it is determined that the service provider terminal deviates from the navigation route, extracting coordinates of a plurality of positioning location points that deviate from the navigation route; determining a target navigation route matching the coordinates of the plurality of positioning location points that deviate from the navigation route based on the coordinates of the plurality of positioning location points that deviate from the navigation route, a coordinate of a current location of the service provider terminal, and a coordinate of the destination of the service provider terminal; updating the navigation route based on the target navigation route.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Furthermore, the recited order of processing elements or sequences, or the use of counts, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in smaller than all features of a single foregoing disclosed embodiment.

In some embodiments, the counts expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present disclosure are not limited to that precisely as shown and described.

1. A method for off-route identification, comprising:
obtaining a first navigation route of an object that is traveling, and one or more positioning location points during traveling;
determining, based on a positional relationship between the one or more positioning location points and the first navigation route, whether a first preset condition is satisfied; and
in response to determining that the first preset condition is not satisfied, determining whether the object is off-route based on information associated with the traveling of the object.

2. The method of claim 1, wherein the first preset condition is configured to indicate that at least one of the one or more positioning location points does not deviate from the first navigation route.

3. The method of claim 2, wherein
the information associated with the traveling of the object includes at least one of an off-route rate, the first navigation route, or a second navigation route, the off-route rate indicating a possibility of off-route for at least one positioning location point that deviates from the first navigation route, the second navigation route being a new navigation route from the at least one positioning location point that deviates from the first navigation route to a first travel destination when the first preset condition is not satisfied; and
the determining whether the object is off-route based on information associated with the traveling of the object comprises:
determining whether the object is off-route based on at least one of the off-route rate, the first navigation route, or the second navigation route.

4. The method of claim 3, further comprising:
determining the off-route rate, comprising:
obtaining one or more historical travel routes associated with the first navigation route; and
determining, based on the one or more historical travel routes, the off-route rate at the at least one positioning location point that deviates from the first navigation route.

5-7. (canceled)

8. The method of claim 1, wherein the determining, based on a positional relationship between the one or more positioning location points and the first navigation route, whether a first preset condition is satisfied comprises:
determining, based on the positional relationship between the one or more positioning location points and the first navigation route, whether there is an off-route point in the one or more positioning location points; and
in response to determining that there is an off-route point in the one or more positioning location points, determining that the first preset condition is not satisfied.

9. (canceled)

10. The method of claim 4, further comprising:
in response to determining that the object is off-route, determining, from the one or more historical travel routes, a second historical travel route that is not off-route at the at least one positioning location point that deviates from the first navigation route;
determining a route similarity between the second navigation route and the second historical travel route; and
sending the route similarity to the object.

11. The method of claim 4, further comprising:
in response to determining that the object is off-route,
determining, based on the one or more historical travel routes and an actual travel route of the object, a new off-route rate at the at least one positioning location point that deviates from the first navigation route; and
updating the off-route rate at the at least one positioning location point using the new off-route rate.

12. The method of claim 1, further comprising:
during the traveling of the object, in response to detecting that the object accepts a joint travel request, and the first navigation route is a navigation route corresponding to a portion of a route from a first departure point of the object to the first travel destination of the object, determining the first navigation route based on a second departure point and a second travel destination in the joint travel request, a current positioning location point of the object, and the first travel destination.

13. The method of claim 2, wherein the one or more positioning location points include at least a current positioning location point, and
the determining, based on a positional relationship between the one or more positioning location points and the first navigation route, whether a first preset condition is satisfied, comprises:
determining, based on the positional relationship between the one or more positioning location points and the first navigation route, whether there is a mapping location point of the current positioning location point on the first navigation route; and
in response to determining that there is no mapping location point of the current positioning location point on the first navigation route, determining that the first preset condition is not satisfied.

14. The method of claim 13, wherein the determining, based on the positional relationship between the one or more positioning location points and the first navigation route, whether there is a mapping location point of the current positioning location point on the first navigation route, comprises:
determining, based on position information of the one or more positioning location points, a first distance between each of the one or more positioning location points and the first navigation route; and
determining, based on the one or more first distances, whether there is the mapping location point of the current positioning location point on the first navigation route.

15. The method of claim 14, wherein the determining, based on the one or more first distances, whether there is the mapping location point of the current positioning location point on the first navigation route, comprises:
determining, based on the one or more first distances, one or more candidate mapping location points on the first navigation route; and
determining, based on travelling direction information of the one or more candidate mapping location points and travelling direction information of the current positioning location point, whether there is the mapping location point of the current positioning location point on the first navigation route.

16. The method of claim 15, wherein the position information includes a coordinate, the travelling direction information includes a direction angle, and the determining, based on position information of the one or more positioning location points, a first distance between each of the one or more positioning location points and the first navigation route, comprises:
determining, based on the coordinates of the one or more positioning location points, a vertical distance from each of the one or more positioning location points to the first navigation route; and
designating the one or more vertical distances as the one or more first distances;
the determining, based on the one or more first distances, whether there is the mapping location point of the current positioning location point on the first navigation route, comprises:
determining, based on the first distance between the each of the one or more positioning location points and the first navigation route, an average vertical distance between the one or more positioning location points and the first navigation route; and
determining, based on the average vertical distance, a coordinate of the current positioning location point, a direction angle of the current positioning location point, and a direction angle of the first navigation route, whether there is the mapping location point of the current positioning location point on the first navigation route.

17. (canceled)

18. The method of claim 13, further comprising:
in response to determining that there is the mapping location point of the current positioning location point on the first navigation route, replacing position information of the current positioning location point with position information of the mapping location point.

19. The method of claim 13, wherein the obtaining one or more positioning location points during traveling comprises:
for each of the one or more positioning location points,
obtaining a precision factor, a direction angle and a speed value of the positioning location point; and
in response to determining that the precision factor of the positioning location point is not greater than a preset precision factor threshold, the direction angle of the positioning location point is not smaller than 0, and the speed value of the positioning location point is not smaller than 0, retaining information of the positioning location point; or
in response to determining that the precision factor of the positioning location point is greater than the preset precision factor threshold, the directional angle of the positioning location point is smaller than 0, or the speed value of the positioning location point is smaller than 0, deleting the information of the positioning location point.

20. The method of claim 13, wherein
the information associated with the traveling of the object includes the information of the one or more positioning location points, and
the determining whether the object is off-route based on information associated with the traveling of the object comprises:
determining whether the object is off-route based on the information of the one or more positioning location points.

21. The method of claim 20, wherein the determining whether the object is off-route based on the information of the one or more positioning location points comprises:
determining a second distance between each of the one or more positioning location points and the first navigation route;
determining, based on the one or more second distances, whether the current positioning location point deviates from the first navigation route; and
in response to determining that the current positioning location point deviates from the first navigation route,
determining, from the one or more positioning location points, deviated positioning location points that deviate from the first navigation route; and
determining whether the object is off-route based on information of the deviated positioning location points.

22. (canceled)

23. The method of claim 21, wherein the information of the one or more positioning location points includes a precision factor and a coordinate of each of the one or more positioning location points, the method further comprising:
determining, based on the coordinate of the current positioning location point, a coordinate of a previous positioning location point of the current positioning location point, and an acquisition time interval between the current positioning location point and the previous positioning location point, an average speed value of the object from the previous positioning location point to the current positioning location point; and
in response to determining that the average speed value is smaller than or equal to a preset speed threshold,
obtaining, based on the precision factors of a plurality of positioning location points including the current positioning location point in the one or more positioning location points, a variance of the precision factors of the plurality of positioning location points, and
in response to determining that the variance of the precision factors is smaller than a preset precision factor threshold, retaining the current positioning location point.

24-26. (canceled)

27. The method of claim 21, further comprising:
in response to determining that the object is off-route, updating the first navigation route based on the information of the deviated positioning location points and the information of the current positioning location point.

28-56. (canceled)

57. A system for off-route identification, comprising:
at least one storage device storing a set of instructions; and
at least one processor in communication with the storage device, wherein when executing the set of instructions, the at least one processor is configured to cause the system to perform operations including:
obtaining a first navigation route of an object that is traveling, and one or more positioning location point s during traveling;
determining, based on a positional relationship between the one or more positioning location points and the first navigation route, whether a first preset condition is satisfied; and
in response to determining that the first preset condition is not satisfied, determining whether the object is off-route based on information associated with the traveling of the object.

58. A non-transitory computer readable medium storing instructions, the instructions, when executed by at least one processor, causing the at least one processor to implement a method comprising:
obtaining a first navigation route of an object that is traveling, and one or more positioning location point s during traveling;
determining, based on a positional relationship between the one or more positioning location points and the first navigation route, whether a first preset condition is satisfied; and
in response to determining that the first preset condition is not satisfied, determining whether the object is off-route based on information associated with the traveling of the object.
